(19) United States
(12) Patent Application Publication
(10) Pub. No.: US 2026/0038525 A1
(43) Pub. Date: Feb. 5, 2026

(54) System And Method For Operating A Device With A Reduced Data Set

(71) Applicant: Board of Trustees of Michigan State University, East Lansing, MI (US)

(72) Inventors: Joshua SIEGEL, Bloomfield Twp, MI (US); Tashfain AHMED, East Lansing, MI (US)

(73) Assignee: Board of Trustees of Michigan State University, East Lansing, MI (US)

(21) Appl. No.: 19/358,686

(22) Filed: Oct. 15, 2025

Related U.S. Application Data
(63) Continuation-in-part of application No. 17/856,652, filed on Jul. 1, 2022.
(60) Provisional application No. 63/710,632, filed on Oct. 23, 2024.

(51) Int. Cl. G10L 19/032; G06F 3/16

(52) U.S. Cl. CPC G10L 19/032; G06F 3/165

(57) ABSTRACT

A method and system for operating a device includes generating a first set of raw data, reducing the first set of data using a plurality of reductions to obtain reduced sets of data and a performance factor for each reduced data set to determine an inflection point relative to the performance factor, determining a second data set reduced from the set of raw data based on a reduction from the plurality of compressions at or below the inflection point, and controlling the device based on the second data set.

### CROSS-REFERENCE TO RELATED APPLICATIONS

This application is a continuation-in-part of U.S. patent application Ser. No. 17/856,652 filed on Jul. 1, 2022, which claims the benefit of U.S. Provisional Patent Application Ser. Nos. 63/217,646 and 63/357,683, filed Jul. 1, 2021 and Jul. 1, 2022, respectively. This application claims the benefit of U.S. Provisional Application No. 63/710,632, filed on Oct. 23, 2024. The entire disclosures of the above applications are hereby incorporated by reference in their entirety, including all figures, tables, and drawings.

### FIELD

The present disclosure relates generally to the field of diagnostics, and more particularly to systems and methods for reducing volume and quality of data while retaining application performance.

### BACKGROUND

This section provides background information related to the present disclosure which is not necessarily prior art.

One contributor to the lifetime efficiency of an engine or vehicle is diagnostics. Diagnostic systems may precisely report faults early, helping to motivate owners and operators to seek out preventative or restorative maintenance. At the same time, mobility culture is evolving, transitioning from individual vehicle ownership towards mobility-as-a-service. Given continued high mobility demands, the average vehicle age and lifetime miles traveled are increasing, particularly in developing countries, and shared mobility services, car rentals, and “robotaxis” are emerging. Increased utilization and novel use cases require enhanced fleet data generation and management capabilities. Automotive diagnostics, i.e., the inference of a vehicle's condition based on observed symptoms indicating technical state, are critical for effective fleet management.

Automotive diagnostics traditionally draw upon in-situ sensors and computation to support “On Board Diagnostics,” making use of data generated within a vehicle to diagnose the vehicle itself. Increasingly, extra-vehicular sensors—added on for diagnostic purposes, or present to enable other applications—may be used.

On-Board Diagnostic systems present on vehicles since 1996 are an automated control system utilizing distributed sensing across a vehicle's embedded systems as a technical solution for measuring vehicle operational parameters and detecting, reporting, and responding to faults. Sensors may capture signals (e.g., vibration, or noise) and algorithms extract and process features, typically comparing these “signatures” against a library of previously-labeled reference values indicating operating state and/or failure mode. If a “rule” is triggered, an indicator is set to notify the user of the fault, and additional software routines may run to minimize the impact of the fault until the repair can be completed (e.g., by changing fuel tables). On-board diagnostic data have also been used to enable indirect diagnostics, for example, using the measured rate of change of coolant temperature to infer oil viscosity and therefore remaining useful life through constitutive relationships and fundamental process physics. Certain on-board diagnostic parameters are required to be reported by the law in certain geographies. In some instances, there may be accuracy requirements. In others, parameters may not be reported or may be reported inaccurately. As a result, on-board diagnostics may not be accurate or effective.

On-board diagnostics are effective at detecting many fault classes, particularly those related to emissions. However, some failure modalities may not be detected by on-board diagnostics, or may be detected with slow response time or poor classification accuracy because:
a) incentive misalignment discourages the use of high-quality (costly) sensors, leading manufacturers to source the lowest cost sensor capable of meeting legislative standards. Relying upon the data generated by these sensors leads to “GIGO” (Garbage In, Garbage Out);
b) diagnostics may be tailored to under-report non-critical failures to improve customer satisfaction, brand perception, and reliability metrics relative to what might be experienced with an “overly sensitive” implementation;
c) on-board diagnostic systems are single-purpose, meaning they correctly identify the symptoms of the faults for which they were designed, but small performance perturbations may not be detected. For example, a system designed to enhance emissions may monitor engine exhaust gas composition continuously, but will not indicate wear or component failures leading to increased emissions until a legal threshold requiring notification is surpassed.

On-board diagnostic deficiencies are amplified by an ever aging vehicle fleet, though older cars can stand to gain the most from the incremental reliability, performance and efficiency improvement enabled by adaptive and increasingly sensitive diagnostics. While newer vehicles may have the ability to update diagnostic capabilities remotely via over-the air updates, older vehicles may lack connectivity or the computational resources necessary to implement these advanced algorithms. And while some diagnostic solutions may make use of manufacturer-proprietary data unavailable to on-board diagnostics, particularly in newer and highly-sensored vehicles, this is not universally true. Further, the sensor payload in the incumbent vehicle fleet is immutable, with no data sources added post-production—that is, the sensors installed at tie of sale are the sensors available at any point in the vehicle's life, and they are unlikely to get better with age. Therefore, the vehicles most in need of enhanced and robust diagnostics are the least-likely to support them. For these reasons, there is a need for updateable, off-board diagnostics capable of sensitive measurement, upgradeability, and enhanced prognostic (failure predictive) capabilities. A low-cost approach, even if imperfect, will enhance vehicle owners; and fleet managers' ability to detect, mitigate, and respond to faults, thereby improving fleet-wide safety, reliability, performance, and efficiency.

As the need for enhanced fleet-side utility grows, so too does the challenge of monitoring increasingly diverse vehicles and their associated, complex subsystems. The same enhancements driving the growth of vehicle sensing and connectivity have simultaneously empowered a parallel advance: namely, the growing capabilities of personal mobile devices. Seventy percent of the world's population is now using smartphones possessing rich sensing, high-performance computation, and pervasive connectivity capabilities enabling a diagnostic revolution.

Pervasive connectivity enables diagnostics to utilize diverse data sources, and supports off-line processing and the creation of diagnostic algorithms capable of adapting over time. This is a result of having access to increased computational resources, enhanced storage capabilities, and richer fingerprint databases for classification and characterization. It also means that “fault definitions” may be updated at a remote endpoint, such that diagnostics may improve performance over time without requiring in-vehicle firmware upgrades (over-the-air or otherwise). To this end, mobile phone computing power has recently increased. Networking capabilities have similarly grown, allowing for inexpensive global connectivity. While some vehicles offer connectivity which may be used to support on-board diagnostics evolution, the use of third-party devices has an additional benefit to manufacturers: with mobile devices, the users not the manufacturer, pays for bandwidth and hardware capability upgrades over time. Mobile phones can augment or supplant the data generated by on-board diagnostics, fusing in-vehicle sensing with smartphone capabilities to enable richer analytics. A framework for fusing multi-source information to return actionable information has been developed, and in another case, accelerometers have been used to improve on-board diagnostics diagnostic accuracy and precision. They may even be used to enhance sensor sampling rate to capture higher-frequency behavior reliably.

Smartphones offer clear benefits over (or in conjunction with) on-board systems, particularly when constraints such as battery life, computation, and network limitations are thoughtfully addressed, and present a compelling enhancement over automotive diagnostics' “business as usual” by offering broad diagnostics with increased sensitivity, and the ability to improve over time-whether through model upgrades, or even federated learning approaches. Though individuals have long used their smartphone inside vehicles, including plugged in and mounted, recent moves toward in-car wireless charging even more firmly establish mobile devices as incredibly powerful automotive sensing and compute devices with few constraints.

Diagnostics (e.g., based on vibroacoustics) may also be used to monitor systems and devices in other fields than the automotive field, such as, for example, factories, utilities, homes, and healthcare.

While vehicle technology is rapidly advancing, fault diagnostics are lesser-explored, whether for trained individuals (such as mechanics), or unskilled individuals (such as vehicle owners and operators). There is a largely-unmet need for a better way to understand the state of vehicles such that operators might better access the information necessary to identify and plan response to impending or latent issues. At the same time, prior work shows that bringing expert knowledge to non-experts can have significant implications for fuel and energy savings as well as safety.

Other industries may also benefit from the use of diagnostics. However, the amount of data may be overwhelming considering the resources in a machine learning environment can be constrained. Efficient data use is important in various systems.

Efficient data use and sensor optimization in resource constrained machine learning systems have been extensively studied, with many efforts focused on data selection, sensor optimization, and network efficiency. The data subset selection problem—choosing the most informative data under system constraints—is known to be NPhard, leading to multi-objective optimization algorithms. For instance, POSS reduces subset size while optimizing selection criteria, but its 2ek2n make suitable for large k and datasets. The distributed version (DPOSS) scales better but degrades significantly in noisy environments and suffers from computational inefficiency or lack generalizability for large-scale applications.

Data compression techniques have been developed to solve specific challenges. For example, one system assigns importance scores to sensor anomalies but struggles with quasi-periodic signals like ECG data. Another system identifies points where data statistical properties change significantly, allowing the system to split the dataset into homogenous segments, though it may not perform optimally for less predictable signals. Real-world implementations face deployment and scalability issues. Dynamic environments, like those faced in synchronizing drones and network variability introduce constraints. These studies highlight the need for a more robust, generalizable framework that can effectively work across domains for data compression.

Sensor selection optimization involving a utility function has been identified as NP-hard. Evolutionary algorithms decompose large-scale IoT problems but rely on computationally expensive methods. Energy-efficient frameworks like Wukong focus on communication energy consumption but lack empirical validation. Similarly, sensor reduction methods for specialized applications, such as medical shoes and dynamic wireless sensor reconfiguration, are effective but fail to generalize across broader constrained computing contexts due to predefined scenarios or scalability issues. Similarly other methods have been used.

Sparse data representation has also been a prominent solution for reducing data volume. These methods acquire compressed data directly, taking advantage of sparsity that may not be consistent across sensors, signals, and applications, limiting generalizability.

Some studies more directly informed our experiments, e.g., one method explored the impact of lowering sampling rates on feature efficacy, by quantizing raw data from 32 bit to 8 bits and down sampling from 44.1 KHz to 5.5 kHz. Another proposed a compressive video sampling framework that optimizes the sampling rate and bit-depth to enhance the rate-distortion performance of video coding in resource-constrained environments finds that even with periodic down sampling (down to 400 Hz) the system maintains a high level of accuracy, suggesting that efficient, low-power cough monitoring via smartphones is feasible. Similarly, Samosa reduces power consumption in microphones while maintaining high recognition accuracy with lower audio sampling rates.

These efforts demonstrate that resource-efficient data handling can maintain ML performance, but they lack a broader framework to generalize insights across different sensing applications.

It would be desirable to have a system and method efficient data handling and condition monitoring.

### SUMMARY

This section provides a general summary of the disclosure, and is not a comprehensive disclosure of its full scope or all of its features.

The disclosure applies to identifying and selecting the Minimum Viable Data (MVD) required for enabling machine learning applications on constrained platforms such as mobile devices, embedded systems and Internet of Things (IoT) devices. This disclosure demonstrates that strategic data reduction can maintain high performance while significantly reducing bandwidth, energy, computation, and storage costs.

This present disclosure provides a holistic approach to data efficiency. Unlike previous efforts that focus on optimizing specific elements (e.g., data capture, transmission, or storage) or specific application (e.g., healthcare monitoring systems, industrial automation, or environmental sensing), the present system and method optimizes the entire data lifecycle and has the ability to generalize across domains. The present disclosure addresses the challenge of balancing data fidelity with resource constraints by identifying the Minimum Viable Data (MVD)—the minimal data needed to meet performance targets in operational settings. This is unlike the MVD definition provided by others, which defines MVD as the minimum data necessary to train an ML model for early phase agile AI prototyping. This enables scalable, resource efficient mobile and constrained system implementations, and overcomes the limitations of prior domain-specific or element focused optimizations.

In accordance with one example, a method and system for operating a device includes generating a first set of raw data, compressing the first set of data using a plurality of reductions to obtain reduced sets of data and a performance factor for each reduced data set to determine an inflection point relative to the performance factor, determining a second data set reduced from the set of raw data based on a reduction from the plurality of reductions at or below the inflection point, and controlling the device based on the second data set.

In another example, a system includes a sensor and a controller programmed to receive a first set of raw data from the sensor. The controller is further programmed to reduce the first set of data using a plurality of reductions to obtain reduced sets of data and a performance factor for each reduced data set to determine an inflection point relative to the performance factor, determine a second data set reduced from the set of raw data based on a reduction from the plurality of reductions at or below the inflection point and control a device based on the second data set.

In another aspect, a method of detecting misfire in a vehicle operating a device includes generating a first set of audio data from an audio sensor positioned within the vehicle, reducing the first set of data using a plurality of reductions to obtain reduced sets of audio data and a performance factor for each compressed data set to determine an inflection point relative to the performance factor, determining a second data set of audio data reduced from the set of audio data based on a reduction from the plurality of reductions at or below the inflection point, determining a misfire based on the second set of audio data, and controlling an engine control module based on determining a misfire from the second set of audio data.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected examples and not all possible implementations, and are not intended to limit the scope of the present disclosure.

FIG. 1 illustrates a method for context-based diagnostic model selection in accordance with an example;

FIG. 2 illustrates a representative model selection process, indicating a means of identifying a vehicle variant and then selecting the most-specific diagnostic model available in order to improve predictive accuracy in accordance with an example;

FIG. 3 illustrates an example method for identifying the vehicle context and using those relevant features to select an appropriate “nearest neighbor” when identifying the optimal diagnostic or prognostic model to choose in accordance with an example;

FIG. 4 is a block diagram of an example system for off-board diagnostics using a method for context-based diagnostic model selection in accordance with an example;

FIGS. 5A and 5B illustrate an example process by which captured engine audio is split into a set of informative features, as well as exploratory data analysis used to inform classifier design in accordance with an example; and

FIGS. 6A and 6B illustrate an example process through which feature sets are loaded in order to test varied classification models in accordance with an example.

FIG. 7 is a conceptual flowchart illustrating how a Cascading approach could perform in accordance with an example.

FIG. 8 is a conceptual flowchart illustrating how a Parallel approach could perform in accordance with an example.

FIG. 9 is a graph depicting resource efficiency in machine learning;

FIG. 10A is a block diagrammatic view of a generic system for determining a minimum viable at set.

FIG. 10B is a flow chart depicting the method for determining a minimum viable data (MVD).

FIG. 11A is a block diagrammatic view of an automotive vehicle incorporating the present disclosure.

FIGS. 11B and 11C are a flow chart of a method for operating the misfire system for the automotive vehicle.

FIG. 12A is a block diagrammatic view of a factory system.

FIG. 12B is a block diagrammatic view of a solar system.

FIG. 12C is a block diagrammatic view of a heating ventilation and air conditioning control system.

FIG. 12D is a block diagram of a water system control system.

FIG. 13A is a block diagrammatic view of an agricultural system.

FIG. 13B is a block diagrammatic view of a logistic/warehouse control system.

FIG. 14 is a plurality of graphs depicting an impact of the sample reduction.

FIG. 15 is a plurality of graphs depicting an impact on a bit depth reduction.

FIG. 16A-16D is a plurality of graphs depicting an impact on simultaneous bit depth sample rate reduction.

FIG. 17 is a plurality of graphs depicting a period clip length reduction.

Corresponding reference numerals indicate corresponding parts throughout the several views of the drawings.

### DETAILED DESCRIPTION

Example examples will now be described more fully with reference to the accompanying drawings.

The present disclosure describes systems and methods for automated context-specific diagnostic model selection. While the present disclosure will be discussed herein in reference to an application for vehicles, it should be understood that the systems and methods for context-based diagnostic model selection may be used in connection with diagnostics and condition monitoring of other types of systems and devices including, for example, systems and devices in the home (e.g., appliances), factories, utilities and critical infrastructure, commercial spaces (e.g., heating, air conditioning, and ventilation systems), aerospace and satellite system, and healthcare.

Given the relatively poor performance of some on-board diagnostic systems and limited potential for further upgrades, there is an opportunity to use users' mobile device as “pervasive, offboard” sensing tools capable of real-time and off-line vehicular diagnostics, prognostics, and analytics. The capabilities of such tools are growing, and they may soon supplant on-board vehicle diagnostics entirely, moving diagnostics from low-cost on-board diagnostics hardware frozen at time of production, to performant, extensible, and easily-upgradable hardware and adaptive software algorithms capable of improving over time. The advantage of this approach goes beyond performance improvements to increase flexibility, enabling diagnostics that address any vehicle—new or old connected or isolated—taking advantage of rich data collection, better characterizable sensors, and scalable computing. Many effective “pervasive” sensing technologies revolve around the concept of remote sensing of sound and vibration utilizing onboard microphones and accelerometers, sensors core to mobile devices. This class of sensing is termed “vibroacoustic sensing,” as it captured vibration and acoustic emissions of an instrumented system.

Vibroacoustic diagnostic methods originate from specialists troubleshooting mechanisms based on sound and feel. The vibroacoustic diagnostic method is non-intrusive, as sound can traverse mediums including air and “open” space and vibration can be conducted through surfaces without rigid mounting. It is therefore an attractive option for monitoring vehicle components. Experientially-trained mechanics may be highly accurate using these methods, though there may be future specialist shortages leading to demand for automated diagnostics.

There has been work to automate vibroacoustic diagnostics. Sound and vibration captured by microphones and accelerometers, for example, has been used as a surrogate for non-observable conditions including wear and performance level. Low-cost microphones have been used to identify pre-learned faults and differentiate normal from abnormal operation of mechanical equipment using acoustic features, providing a good degree of generalization. Like sound (which itself is a vibration), vibration has been used as a surrogate for wear with increasing intensity over time reasonably predicting time-to-failure. In fact, accelerometers have also been used to infer machinery performance using only vibration omissions as input. Vibrational analysis may be coupled with other sensing modalities, including on-board diagnostic systems, to improve diagnostic accuracy and precision, or used in lieu of onboard measurements.

Vibroacoustics, counterintuitively, may be more precise than onboard diagnostics because air gaps provide a mechanism for isolating certain sounds and vibrations from sensors. While vibration may therefore be used to capture “conductive” time-series data, acoustic signals may be preferable in certain applications as the mode of transmission may serve to pre-condition input data and may transmit information related to multiple systems simultaneously. In some applications, mechanical vibration may be more informative than sound. An example is the classification of bearing operating states in an industrial environment using vibration signals along with rough sets theory for diagnostics, yielding high classification performance using analytical methods. Some diagnostic fingerprints are developed based on understanding the underlying physical process, whereas others are latent patterns learned from experimental data collection.

Real-world systems have inputs including energy, materials, control signals, and perturbation. It is possible to directly measure inputs, outputs, and machine performance, but indirect measurement of residual processes (heat, noise, etc.) may be less-expensive and equally useful diagnostically. Vibration and sound are energy emissions stemming from mechanical interactions. Due to inherent imperfections, even precisely-manufactured and maintained rotating assemblies, such as gear meshes, may be modeled as a series of repeated impact events producing a characteristic noise or lateral motion.

If one understands these processes, it becomes possible to model them and to engineer a series of features useful for system characterization. Modelling and processing techniques include frequency analysis, cepstrum analysis, filtering, wavelet analysis, among others. These generate features that a more robust to small perturbations and therefore resistant to overfit when used in machine and deep learning algorithms. Other features describing waveforms may provide better discriminative properties. The features selected are informed by the engineer's knowledge of the physical process and what she or he believes likely to be informative in differentiating among particular states. Careful feature selection has the potential to improve diagnostic performance as well as reducing computation time, memory and storage requirements, and enhancing model generalizability.

Though vibroacoustics is a compelling solution, it requires significant and diverse training to achieve high performance and classification or gradation algorithms may be computationally-intensive and tailored to highly-specific systems. Accepting minimally-reduced performance to enhance algorithm generalizability and reduce computational performance, and/or shifting computation to scalable Cloud platforms, has the potential to make vibroacoustics more powerful as a condition monitoring and preventative maintenance tool for vehicles and other systems.

At the same time, smartphone processing power is increasing, and it may be possible to use a mobile device as a platform for real-time acoustic capture and processing, and to do the same for vibration capture and analysis.

Algorithms trained on few measurements may be inherently unstable, so multi-device crowdsourcing improves acoustic measurement classification confidence. Diverse, distributed devices lead to better training data and enhanced confidence in diagnostic results, though it is challenging to balance accuracy with system complexity and to ensure samples represent usable signals rather than background noise. These challenges can be managed with careful implementation, helping pervasively-sensed vibroacoustics attain strong performance when utilizing system-specific models for diagnostics and provide maintenance within automotive and other contexts. Example automotive application include: a) vehicle identification and component-level diagnostics; b) occupant and driver behavior monitoring and telemetry; and c) environmental measurement and context identification (e.g., road composition and state of repair). In addition to these existent applications, the present disclosure describes systems and methods to improve the vibroacoustic performance through improved contextual awareness as described further below.

Vehicles are increasingly complicated, though their mechanical example typically comprises systems that translate and rotate, vibrating through use. There is a corpus of prior development focused on analysis of such systems. In one example, an automated means of extracting robust features from rotating machinery was developed, using an auto-encoder to find hidden and robust features indicative of operating condition and without prior knowledge or human intervention. Mechanical systems wear down, leading to different operating states that a diagnostic tool must be able to detect in order to time preventive maintenance properly. To address this need, a “sound detective” was developed to classify the different operating states of various machines.

In another example, a prior approach to vibrational analysis utilizes constrained computation and embedded hardware. A Raspberry Pi was used to diagnose six common automotive faults using deep leaning as a stable classification method (relative to decision trees), comparing four neural network architectures. It is unclear how these results generalize to other vehicle types and configurations, and whether they are less-sensitive to small data perturbations than other techniques. The use of a constrained system demonstrates the potential scalability of vibroacoustic approaches to mobile devices and those with similar capabilities.

Automotive engines, as with other reciprocating machinery, may be difficult to diagnose because of the coupling among subsystems. Engines generate sound stemming from intake, exhaust, and fans, to combustion events, valve-train noise, piston slap, gear impacts, and fuel pumping. Each manifests uniquely and transmits across varied transmission pathways. For this reason, audio may be more suitable than vibration for identifying faults as the air-transmission path eliminates some system-coupling, making it easier to disaggregate signals.

It may be difficult to select the appropriate degree of abstraction in generating reference features, and a highly-abstracted vibroacoustic emission model for diagnostics has been developed. In many studies, complete and accurate physical fault models are not available, so signal processing and machine learning techniques help improve classification performance. There are techniques for signal decomposition to better-highlight and associate features with significant engine events, and it may be possible to guise classification tools through created feature engineering including time-frequency analysis, or wavelet analysis.

Sensing engines can be done on resource-constrained devices and still enable continuous monitoring, with hardware-agnostic algorithm implementations. Another example of a prior technique used an Android mobile device to record vehicle audio, create frequency and spectral features, and detect engine faults by comparing recorded clips with reference audio files, where the developers could detect engine start, drive belt issues, and excess valve clearance.

Engine misfiring is typical within older vehicles die to component wear. Misfires have been detected in a contact-less acoustic method with 94% accuracy, relative to 82% accuracy attained from vibration signals. Without opening the hood and recording at the exhaust, the developers reached 85% classification accuracy from audio (which again outperformed vibration). While some algorithms have been developed without physical process knowledge, others make use of system models to improve diagnostic performance. Use of aspects of the physical model can help reduce algorithm complexity, requiring a feature engineering work before analyzing the input data.

In another prior technique, feature extraction was used to reach 99% fault classification accuracy in a study of misfire, well exceeding other prior techniques. This technique demonstrates that feature selection and reduction techniques based on Fisher and Relief score are effective at improving both algorithm efficiency and accuracy, as well as the concept of “Pareto Data”-data captured from low-quality sensors that have the potential to deliver high value when appropriately processed. In this case, data was collected from a commodity smartphone microphone. Similar acoustic data and engineered features have been successfully used to monitor the condition of engine air filters, helping to precisely time change events without the need for costly, high-fidelity, calibrated sensors.

In some example feature engineering techniques, such as wavelet packet decomposition used in the misfire and air filter techniques described above, have found application in other engine diagnostic contexts such as identifying excessive engine valve clearance and combustion events. Other common faults relating to failed engine head gaskets, valve clearance issues, main gearbox, joints, faulty injections and ignition components can also be detected thanks to vibrational analysis. Transmission, too, may be monitored, and a damaged tooth in a gear can be diagnosed capturing sound and vibration at a distance. Even high-speed rotating assemblies, such as turbochargers can be monitored-turbocharging is increasingly common to meet stringent economy and emissions standards, and engine compression surge has been identified and characterized by sound and vibration.

Non-automotive engines and fuel type can also be identified using vibroacoustic approaches. Smartphone sensors may be used to classify normal and atypical adjustments of tractor engines with 98.3% accuracy, and fuel type can be determined based on vibrational mode—with 95% accuracy.

Other prior techniques have used physics to guide feature creation for indirect diagnostics, e.g., measuring one parameter to infer another. For example, in one prior technique the developers used engine temperature over time as a surrogate measure for oil viscosity and found promising results relating dT/dt to viscosity. As it turns out, vibration may be used as further abstraction. By measuring engine vibration, one may determine the engine speed (RPM) and it may be possible to determine whether the car is in gear to identify when the car is at rest. Using knowledge of the car's warm up procedure (which typically involves so called “fast idle” until the engine warms up to temperature, to reduce emissions), it may be possible to time how long it takes to go from fast idle (where the engine runs quickly to warm up and therefore reduce emissions) to slow idle and infer temperature from vibration, thereby creating a means of inferring oil viscosity from vibration alone and without the use to onboard temperature data.

Prior mobile applications have been developed for minimizing the knowledge gap between vehicle operators and expert mechanics. In one example, sound may be used to improve diagnostic precision relative to that of untrained users. Intelligence may be embedded in a mobile application wherein a user uploads a recording of a car, and answers related questions to produce a diagnostic result. The application works by reporting the label of the most-similar sample in a database as determined by a convolutional neural network (VGGish model). Peak diagnostic accuracy is 58.7% when identifying the correct class from twelve possibilities.

Algorithms have the most value when they are transferable, as they can be trained on one system and applied to another with high performance. In an example, transferability across similar engine geometries of different cars may be considered in the context of detecting piston and cylinder wear and measuring valve-rain and roller bearing state.

Powertrain diagnostics are important, but they are equally important to instrument other vehicle subsystems. Offboard diagnostics may be applied to vehicle suspensions as a means of improving performance, safety, and comfort.

As with powertrain diagnostics, suspensions may be monitored using vibroacoustic analysis, optical and other methods, or a combination of both. In terms of vibroacoustics, wireless microphones have been used to monitor wheel bearings and identify defects based on frequency domain features, and vibration analysis has been implemented to detect remaining useful life of mechanical components such as bearings. Similar data and algorithms have been exploited to identify the emergence of cracks in suspension beams.

Other vibroacoustic approaches have been implemented using accelerometers and GPS to measure tire pressure, tread depth, and wheel imbalance, primarily using frequency-based features. Such solutions could be extended to instrumenting brakes, using frequency features and low-pass acceleration to measure specific pulsations occurring only under braking, or gyroscopes, to measure events taking place only when turning (or driving in a straight line).

As mentioned above, prior studies have demonstrated a means of diagnosing six vehicle component faults using vibration and Deep Leaning Diagnostics algorithms running within constrained compute environments. Some of these diagnostics target wheels and suspensions, specifically at wheel imbalance, misalignment, brake judder, damping loss, wheel bearing failure, and constant-velocity joint failure. Each fault may be selected as manifesting with characteristic vibrations and occurring at different frequencies. This technique required vehicles to be driven at particular speeds in order to maximize signal. Accuracy varies, with a peak Matthew Correlation Coefficient of 0.994—however, a small sample size and randomly-generated datasets with replacement may lead to overfit, artificially heightening the reported performance.

Aside from accelerometers and GPS, other sensor measurands have been explored in the context of suspension diagnostics, with classification and gradation algorithms making use of sensors including mobile phone cameras. In one application, smartphone cameras may be used to identify tire degradation resulting from oxidation and cross-linking failures based on the appearance of characteristic patterns identifiable with a convolutional neural network. In this application, the concept of “embedded intelligence” was used, which took specialized knowledge (knowledge both that tires degrade over time, and the method through which degradation manifests and becomes visible) and built it into a tool deployable across hardware variants and requiring no training to operate effectively. The existence of the application itself made vehicle owners and operators aware of potential risks and fault modalities and brought expert-level assessment to the hands of any user with a mobile device with a camera and internet connection.

Recent studies have utilized MEMS accelerometers to investigate vehicle vibration indicative of vehicle body state and condition. Specifically, MEMS accelerometers allow the diagnosis of articulation events in articulated vehicles, e.g. buses. In one study, sensors were placed within the vehicle, with one located within each of the two vehicle segments in order to detect articulation events and monitor changes in bearing play resulting from wear and indicating a need for maintenance.

Vehicle occupants value fit and finish and a pleasant user experience while riding in a vehicle. To this end, there is an unmet need for real-time noise, vibration, and harshness (NVH) diagnostics. Vibroacoustics and other offboard techniques may find application in identifying and remediating the source of squeaks, rattles, and other in-cabin sounds in vehicles after delivery from the factory.

Beyond monitoring vehicle condition and maintenance needs, offboard diagnostics have the potential to identify vehicle operating state in real-time, e.g. to identify whether a vehicle is moving or not, the position of the throttle, steering, or braking controls, or in which gear the selector is currently placed. To this end, mobile devices can be used to enable sensitive classification algorithms making use of accelerometers and cameras.

At their simplest, mobile devices may be used to detect mode of transit, such as whether someone is in a car and driving. Some context-aware applications use sensor data to detect whether a vehicle is moving, and if so, to undertake appropriate actions and adaptations to enhance occupant safety, e.g. by disabling texting while in motion. The aforementioned study made use of accelerometers to supervise and eliminate false positive events from the training dataset, ultimately yielding a performance with 98% specificity and 97% sensitivity.

Others have used similar data to detect the operating state of a vehicle in order to identify lane changes or transit start- and end-points, using smartphones. The overall accuracy attained depends on the algorithm used and classification label, but ranges from 78.3% to 88.6% for one tree-bagging method.

Vehicle operating state may also be monitored and various areas of development which are being explored include:

Accelerometer-based accident detection and response, for example, smartphones may be used to detect and respond to incidents taking place on all-terrain vehicles and capable of differentiating “normal” driving from simulated accidents with over 99% confidence. Some approaches use these data to automate rerouting.

Mobile phone cameras may be used to detect a vehicle's distance to leading traffic, providing real-time contextual information and situational awareness while affording older vehicles the benefits of modem (and typically expensive) advanced driver assistance systems.

Using K-means clustering with acceleration data to identify driving modes, such as idling, acceleration, cruising, and turning as well as estimating fuel consumption (there are multiple methods for using mobile sensors as surrogate data to indirectly estimate fuel consumption).

Another example application of pervasive sensing and offboard diagnostics is to occupant state and behavior monitoring.

Many automotive incidents resulting in injury or harm to property result from human activity. It is therefore essential to monitor not only the state and condition of a vehicle, but also to supervise the driver's state of health and attention in order to reduce unnecessary exposure to hazards and to promote safe and alert driving.

Occupant monitor (including drivers and passengers) may be grouped broadly into three categories:

Occupant State, namely health and the capacity to pay attention to and engage with the act of driving.

Occupant Behavior, namely the manner of driving, including risks taken and other parameters informing telemetry, e.g. for informing actuarial models for insurers or for usage-based applications.

Occupant Activities, namely the actions taken by occupants within the vehicle (e.g. texting), with particular application to preventing or mitigating the effects of hazardous actions.

Vehicle occupant state may be monitored for a variety of reasons, e.g. related to drowsiness, drunkenness, or drugged behavior. Mobile phones may be used to detect and report drunk driving behavior, with accelerometers and orientation sensors informing driving style assessments indicative of drunkenness. In another example, mobile device camera images may be used to measuring occupant alertness. Drowsiness may also be monitored using smartphone data, helping to inform ADAS systems.

The main issue with occupant state may be related to drunk driving state. With mobile phones placed in the vehicle there may be the opportunity to detect that particular condition observing both the driving style (using accelerometers and orientation sensors) and the driver alertness monitoring the eye state with mobile device camera. As with vehicle diagnostics, multiple sensor types may be used to monitor driver state.

Counterintuitively, as highly automated driving grows in adoption, there will be growing demand for occupant metrics at first, to ensure that drivers are “safe to drive,” and later, to make judgments as to how much to trust a driver's observations and control inputs relative to algorithms, e.g. to trust a lane keeping algorithm more than a drunk driver, but less than a sober driver.

Smartphones have been widely deployed in order to develop telematics applications for vehicles and their occupants, using exteroceptive sensing to support “off board supervision”. These data may be used by insurance companies to monitor driver behaviors and to develop bespoke policies reflecting real-world use cases, risk profiles, and driver attitudes.

One example prior study explores the performance of smartphone-derived data as it relates to algorithm performance, device capabilities, power consumption, positioning accuracy, and driver behavior, as applied to travel mode, time and routing, maneuvering, aggression, eco-friendliness, and reactiveness, all of which are critical to informing telemetry algorithms such as vehicle tracking or insurance.

Pervasively-sensed data may be used in three main insurance contexts, helping to:

Monitor a driver and/or vehicle's distance traveled, supporting usage-based insurance premiums.

Supervise eco-driving, using metrics such as vehicle use or driver behavior (including harshness of acceleration and cornering, with demonstrated performance achieving more than 70% accurate prediction) to guide more-conservative behavior. Related to this, vehicle speed can be monitored with smartphone accelerometers alone, with an accuracy within 10 MPH of the ground truth.

Observe driver strategy and maneuvering characteristics, to assess actuarial risk and feed models with real-world data to inform premium pricing. This information may be used as input into learned statistical models representing drivers, vehicles, and mobile devices to detect risky driving maneuvers. Notably, driving style and aggression level can be detected with inexpensive multi-purpose mobile phones and vehicles or drivers may be tracked to identify the potential for high risk operation, in cases with no additional sensors installed in the vehicle.

Other behavior monitoring and telemetry use cases may relate to safety, providing intelligent driver assistance by estimating road trajectory, using smartphones to measure turning or steering behavior (with 97.37% accuracy), classifying road curvature and differentiating tum direction and type, or offering even-finer measure of steering angle to detect careless driving or to enhance fine-grained lane control. Some mobile phone data may identify driving events in order to inform path planning algorithms. In an example, straight driving, stationary, turning, braking, and acceleration behaviors may be identified independently on the orientation of the device. These approaches may use several learning approaches, though many use end-to-end deep learning framework to extract features of driving behavior from smartphone sensor data.

Human activity recognition has been widely studied outside vehicular contexts, and the performance of such studies suggest a likely transferability to vehicular environments, with pervasive (ambient) or human monitoring gaining prominence. In the present disclosure, in-vehicle and non-vehicular activity recognition may be considered.

In the present disclosure, three categories of “off-board” sensing for human activity recognition may be considered:

In vehicle activity recognition: Similarly to the use of pervasive sensing for drunk driver detection, mobile sensing may be applied to the recognition of non-driving behaviors within vehicles, for example distracted driving and texting-while-driving. Detecting texting-while-driving may be based upon the observation of turning behavior, as measured by a single mobile device. Mobile sensing solutions making use of optical sensors may also be demonstrated to detect driving context and identify potentially-dangerous states. A survey of smartphone-based sensing in vehicles may be used for activity recognition within vehicles including driver monitoring and the identification of potentially-hazardous situations.

Workshop activity recognition: Human-worn microphones and accelerometers may be used to monitor maintenance and assembly tasks within a workshop, reaching 84.4% accuracy for eight-state task classification with no false positives. In another example, similar sensors may be used to differentiate class categories included sawing, hammering, filing, drilling, grinding, sanding, opening a drawer, tightening a vice, and turning a screwdriver using acceleration and audio data. For user-independent training, one example study attained recall and precision of 66% and 63% respectively. The methods demonstrated in identifying different work- and tool-use contexts may provide the basis for identifying human engagement with various vehicle subcomponents, e.g. interaction with steering wheels, pedals, or buttons, helping create richer “diagnostics” for vehicle occupants and their use cases.

General activity recognition: Beyond identifying direct human-equipment interactions, mobile sensing may be applied to the creation of context-predictive and activity-aware systems. Wearable sensors and mobile devices with similar capabilities may be used to detect user activities including eating, drinking, and speaking, with a four-state model attaining in-the-wild accuracy of 71.5%. In another study, user tasks may be identified over a 10-second window with 90% activity recognition rate. In vehicles and mobile devices, computation is often constrained. Activity classification may be performed using microphone, accelerometer, and pressure sensor from mobile devices in a low-resource framework. This algorithm was able to recognize 15-state human activity with 92.4% performance in subject-independent online testing.

Related to tailoring user experience, acoustic human activity recognition is an evolving field aimed at improving automotive Human Machine Interfaces (HMI) suitable across contexts. In one example study, 22 activities were investigated, and a classifier was developed reaching an 85% recognition rate. Acoustic activity recognition may also be applied directly to general activity detection.

In consumer electronics, activity or context recognition may be used to detect appliance use or to launch applications based on context or used as sound labeling system thanks to ubiquitous microphones. Sound labeling and activity/context recognition may help augment classification approached by defining a context (environment) in order to limit the set of classes to be recognized before classifying an activity based on available mined datasets. In one sample application, 93.9% accuracy was reached on prerecorded clips with 89.6% performance for in-the-wild testing. The demonstrated system was able to attain similar-to-human levels of performance, when compared against human performance using crowd-sourcing service Amazon Mechanical Turk. In another example study, human feedback may be used to provide anchor training labels for ground truth, supporting continuous and adaptive learning of sounds.

Detecting activities within a vehicle-using acoustic sensing or other approaches may help to tailor the vehicle user experience based on real-time use cases. Using techniques for general activity recognition and applying this to an automotive context has the potential to improve the occupant experience as well as vehicle performance and reliability. Of course, monitoring vehicles and their occupants alone does not yield a comprehensive picture of a vehicle's use case or context: the last remaining element to be monitored is the environment.

Environment monitoring is a form of off-board diagnostic that may help to disaggregate “external” challenges from problems stemming from the vehicle or its use, e.g. in separating vibration stemming from cracks in the road from vibration caused by warped brake rotors. Environment monitoring is also a crucial step towards autonomous driving, helping algorithms understand their constraints and operate safely within design parameters.

Already, smartphones can be used as pervasive sensors capable of complementing contemporary ADAS implementations. In one example study, vehicle parameters recorded from a mobile device accelerometer may be used to measure road anomalies and lane changes. Vibroacoustic and other pervasively-sensed measurements may also be used for environment analysis. These may be used to calibrate ADAS systems by monitoring road condition, to classify lane markers or curves, to measure driver comfort levels, and as traffic-monitoring solutions. Some example pervasively-sensed environment monitoring approaches are described in the following.

Pavement road quality can be assessed by humans, though mobile-only solutions may be lower-cost, faster, or offer broader coverage. Accelerometers may be used for detecting defects in the road such as potholes or even road surface type (e.g. gravel detection, to adapt antilock braking sensitivity) or speed bump locations. Road-surface materials and defects may also be detected from smartphone-captured images using learned texture-based descriptors. It is also relevant to consider the weather when monitoring the road surface condition for safety, and microphone-based systems have demonstrated performance in detecting wet roadways. Captured at scale, smartphone data may be used to generate maps estimating road profiles, weather conditions, unevenness, and mapping condition more precisely and less expensively than traditional techniques, with enhanced information perhaps improving safety. These data may be used to report road and traffic conditions to connected vehicles.

Curve data and road classification may integrate with GPS data to increase the precision of navigation system. Mobile phone IMU's have been used to differentiate left from right and U-turns, and it is reasonable to believe that combining camera images with IMU data (and LiDAR point clouds, if available), may help to generate higher-fidelity navigable maps for automated vehicles.

The comfort level of bus passengers has been investigated with mobile phone sensors, attaining 90% classification accuracy for defined levels of occupant comfort.

Mobile sensing may be used to detect parking structure occupancy.

Acoustic analysis of traffic scenes with smartphone audio data may be used to classify the “busyness” of a street, with 100% efficacy for a two-state model and 77.6% accuracy for a three-state model. Such a solution may eliminate the need for dedicated infrastructure to monitor traffic, instead relying on user device measurements. In an example, developers implemented a 10-class model, classifying environments based on audio signatures indicating energy modulation patterns across time and frequency and attaining a mean accuracy of 79% after data augmentation. Audio may also be used to estimate vehicular speed changes, and vibration may be, as well-using a convolutional neural network to estimate speed while eliminating the drift typically associated with double-integrating accelerometer data.

Offboard sensors lead many lives—as phones, game playing devices, and diagnostic tools—so it is important for devices to be able to identify their own mobility use context. One example approach uses mobile device sensors and Hidden Markov Models to detect transit mode, choosing among bicycling, driving, walking, e-bikes, and taking the bus, attaining 93% accuracy, which may be used to create transit maps and/or to study individuals' behaviors.

Though the approaches described relate primarily to cars, trucks, and buses, many solutions apply to other vehicles as well. Off-board diagnostics for additional vehicle classes are described below.

Off-board and vibroacoustic diagnostics capabilities may be used for non-automotive, truck, or bus-type vehicles, including planes, trains, ships, and more.

As with cars, train suspensions and bodies may be instrumented using vibroacoustic sensing. Train suspensions may be instrumented and monitored using vibrational analysis. Brake surface condition may also be monitored with vibroacoustic diagnostics. Train bodies (NVH) may also be monitored, notably the doors on high-speed trains. Their condition may be inferred with the use of acoustic data.

Aerial vehicle propellers are subjected to high rotational speeds. If imbalanced or otherwise damaged, measurement of the resulting vibrations may lead to rapid fault detection and response.

In maritime environments, vibroacoustic diagnostics may be implemented with the use of virtualized environments and virtual reality to allow remote human experts with access to spatial audio and body-worn transducers to diagnose failures remotely.

The present disclosure describes systems and methods for context-based diagnostic model selection that may utilize vibroacoustic diagnostic, pervasive sensing and shared mobility. In some examples, the systems and methods may use mobile device sensors alone or use such offboard sensors to compliment in-vehicle hardware. In some examples, the offboard sensors may be implemented in a wearable device. In some examples, the sensors may be integrated into the measured and monitored system.

Often, classification relies upon generalizable models to ensure the broadest applicability of an algorithm, perhaps at the expensive of performance. Occasionally, classifiers—such as activity recognition algorithms—may make use of “personalized” models. Personal Models are trained with a few minutes of individual (instance-specific) data, resulting in improved performance. This approach may be extended from activity recognition to off-board vehicle diagnostics, with the creation of instance- or class-specific diagnostics algorithms. Selecting such algorithms may therefore require the identification of the monitored instance or class.

The present disclosure describes a context-based model selection system and method, aimed at identifying the instrumented system precisely such that tailored models may be used for diagnostics and condition monitoring.

Differentiating among, for example, makes, models, and use contexts for a monitored system (e.g., a vehicle, appliance, ventilation system, etc.), may allow tailored classification algorithms to be used, with enhanced predictive accuracy, noise immunity, and other factors-thereby improving diagnostic accuracy and precision, and enabling the broader use of pervasive sensing solutions in lieu of dedicated onboard systems.

Automotive enthusiasts can detect engine types and often specific vehicle make and models from exhaust notes alone—and researchers have demonstrated success using computer algorithms to do the same, recording audio with digital voice recorders, extracting features, and testing different classifiers—finding that it is possible to use audio to differentiate vehicles. The more the application knows or infers about the instrumented system, the more accurate the diagnostic model implemented may become.

In some examples, a contextual identification system and model selection tool may be configured to improve diagnostic accuracy and precision for vibroacoustic and other ambient sensing, and other approaches including, for example, time-series current data. In some examples, the systems and methods described herein utilize Contextual Activation, i.e. the ability for a mobile or wearable device to launch a diagnostics application in background when needed, just as it might instead load, for example, a fitness application when detecting motion indicative of running.

In some examples, the systems and methods may be implemented as an application or software on a mobile device. With the application launched, sensor samples may be recorded, e.g. from the microphone and accelerometer. These data may then be used to identify the vehicle and engine category, perhaps classifying these based entirely on the noise produced, or in concept with additional data sources, such as a connected vehicle's Bluetooth address, its user/company's vehicle management database and so on. In some examples, the systems and methods may be implemented as an application or software on a wearable device.

Once the vehicle and variant are identified, this information may be used to identify operating mode, and from this, a “personalized” algorithm may be selected for diagnostic or other activities.

In some examples, in aggregate the system may operate similarly to a decision tree—by selecting the appropriate leaf corresponding to the vehicle make, variant, and operating status, it may be possible to select a similarly-specific or diagnostic algorithm or model tailored to the particular nuance of that system. In some examples, implemented carefully, the entire system may run seamlessly, such that the sensor sample may be captured, the context may be identified, and the user may be informed of issues worth her or his time, attention, and money to address. This seamlessness may key to the success of the described pervasive sensing concept—to maximize the utility of a diagnostic application, it must require minimal user interaction.

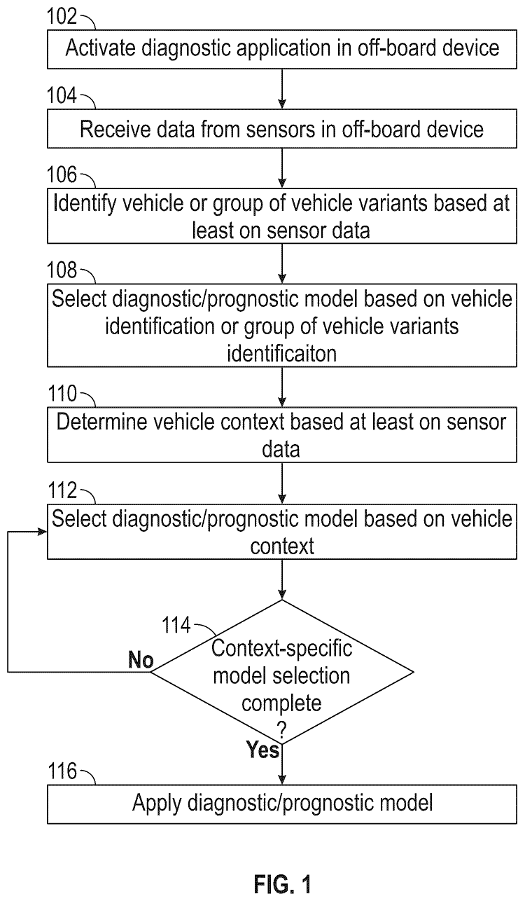

FIG. 1 illustrates a method for context-based diagnostic model selection in accordance with an example. As mentioned above, while FIG. 1 will be discussed herein in reference to an application for vehicles, it should be understood that the method for context-based diagnostic model selection may be used in connection with diagnostics and condition monitoring of other types of systems and devices. At block 102, the diagnostic application in an off-board device (e.g., a mobile device such as a smartphone, a wearable device, etc.) may be activated. In some examples, the use of contextual activation may enable the application to operate data capture only when the off-board device is in or near a vehicle, and the vehicle is in the appropriate operating mode for the respective test (e.g. on, engine idling, in gear, or cruising at highway speeds on a straight road). This may allow the software (built as a dedicated application inside the off-board device), in some examples, to operate as a background task or to be launched automatically when the off-board device detects it is being used within an operating vehicle.

In some examples, implementations of the described automatic, context-based software execution may include automatic application launching when the phone is connected via Bluetooth to the car, or when a mapping or navigation application is opened. In the example of launching the application when a mapping or navigation application is opened, the GPS and accelerometer may be utilized to understand the specific kind of road the vehicle is running on, as well as its speed, e.g. to disallow certain algorithms such as those used to detect wheel imbalance from running on cracked or gravel roads.

At block 104, data from the monitored system, for example, a vehicle, may be received that was acquired or sampled by one or more sensors in the off-board device. For example, in some examples, acoustic and vibration data may be acquired using a microphone and an accelerometer, respectively. In some examples, the sensors in the off-board deice may be other types of ambient sensing devices. The data may be provided directly from a sensor or may be retrieved from data storage or memory. As mentioned above, the use of contextual activation may enable the application to operate data capture only when the off-board system (e.g., a mobile device, a wearable device, etc.) is in or near a vehicle, and the vehicle is in the appropriate operating mode for the respective test (e.g. on, engine idling, in gear, or cruising at highway speeds on a straight road).

Some examples of the context-based diagnostic model selection system and method may comprise a “context layer” for generating characteristic features and/or uniquely—identifiable “fingerprints” for a particular system (e.g., a vehicle), which may then pass system—level metadata (system type, other details, and confidence in each assessment), along with raw data and/or fingerprints to a classification and/or gradation system. This “context layer” may be used both in system training and testing, such that recorded samples may exist alongside related metadata and therefore may allow for classification and gradation algorithms to improve over time, as increasing data volume generates richer training information even for hyper-specific and rare system configurations.

The described application may therefore capture raw signals and preprocess engineered features to be sent to a server (these fingerprints are space-efficient, easier to anonymize, more difficult to reverse, and repeatable), uploading these data at regular intervals or triggered upon a particular event.

At block 106, vehicle identification, or identification of a grouping of similar vehicle variants is performed. Depending on the system in the vehicle to be diagnosed, similarities may take place as a result of engine configuration, suspension geometry, and so on.

A vehicle “group” may be identified by, for example, engine type—that is, configuration, displacement, and other geometric and design factors. For example, an engine may be classified to be gasoline powered, with an inline configuration, having 4 cylinders with 2.0 liters of displacement, turbocharged aspiration, and manufactured by Ford.

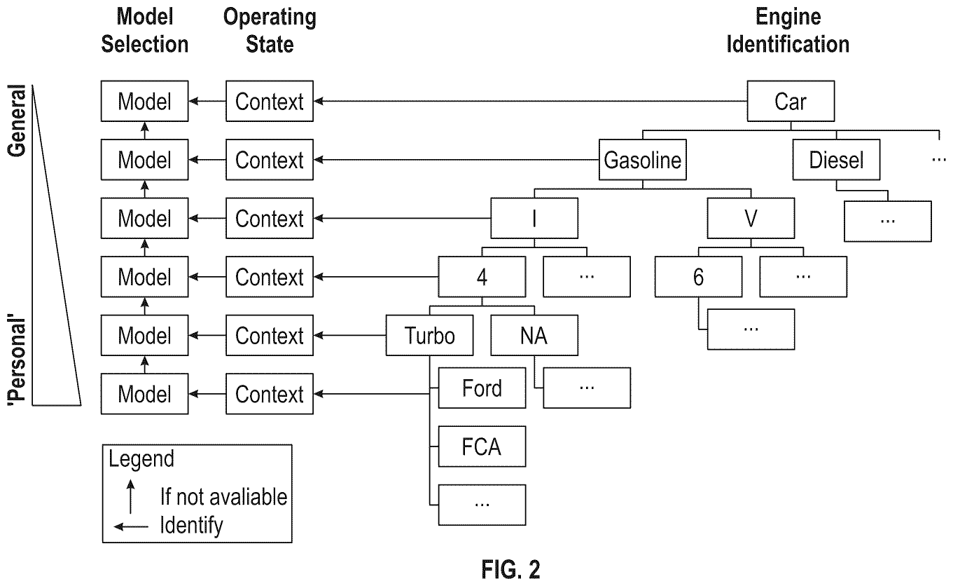

At block 108, a diagnostic or prognostic model (e.g., an instance-specific model) may be selected based on the vehicle identification or the identification of a group of vehicle variants. The selected model may be stored in, for example, a database of diagnostic models. The database may be stored on the off-board device or may be a remote database stored on a computer system or server in communication with the off-board device via a wired or wireless connection. If a database does not include any available diagnostic algorithm (e.g. a misfiring test) for the identified engine type, increasingly less-specific parent class models may then be looked at, such as generic car-maker-independent gasoline 14 2.0 turbo engine. If this is also not available, the process may go higher—and higher-level until it is necessary to use the least-specific model, in this case, a model trained for all gasoline engines—at the cost of potentially-decreased model performance. Alternatively, a similar engine may be considered for use, with slight difference in displacement or powered by LPG fuel. FIG. 2 illustrates a representative model selection process, indicating a means of identifying a vehicle variant and then selecting the most-specific diagnostic model available in order to improve predictive accuracy.

In some examples, by extending this process, it may become possible to identify a particular vehicle instance, particularly based on features learned over time (e.g. indicating wear).

Other subsystems, such as bodies and suspensions, may also be identified using the disclosed systems and methods. For example, identifying operating context and road condition may be used to identify when a car hits a pothole, with the post-impact oscillations indicating the spring rate, mass, and damping characteristics indicative of a particular vehicle make or model. As with engines, in some examples subtleties may be used to identify vehicle instances, e.g. damping due to tire inflation.

In some examples, if the vehicle is known to the off-board device user and “short list” of vehicles frequented by the user, this portion of the classification may be replaced by ground-truth information, or selection may be made among a smaller/constrained subset of plausible options. Moreover, if the application is activated based on the Bluetooth connection indicating proximity to a particular vehicle, it may be identified with near-certainty. In order to reduce the degree of user interaction required, this and other automation tools may be used to identify vehicles and operating context in order to run engine and other diagnostics as a sort of background process.

Once the vehicle is selected, at block 110 its context may be identified based on at least the sensor data. In some examples, context classification may use vibroacoustic cues (and vehicle data, if available) to identify the operating state of, for example, the engine, gearbox, and body. For example, is the engine on or off? If it is on, what is the engine RPM? Is the gearbox in park, neutral, or drive—or if a manual transmission, in what gear is the transmission, and what is the clutch state? In some examples, the context may include the system type, configuration, and instance identity in addition to the use case, operating mode, environmental factors, etc.

At block 112, a diagnostic or prognostic model (e.g., a context-specific model) may be selected based on the identified vehicle context from block 110. Some models or algorithms may be able to operate with minimal information related to vehicle context (e.g. diagnosing poor suspension damping may require the vehicle simply to be moving as determined by GPS, whereas measuring tire pressure may require knowing the car is in gear and headed straight to minimize the impact of noise and other artifacts on classification performance).

In some examples, with context selection, a similar process may be used to that used for vehicle type and instance identification, namely, selecting the model with metadata best reflecting the instrumented system to ensure the best fit and performance.

In an example implementation, a decision tree may be created to identify the current vehicle state—with consideration given to engine operating status, gear engagement, motion state, and other parameters—and rather than using this tree to select a model for diagnostics, this tree may be pruned to suit a particular diagnostic application's needs (e.g. engine power might not matter for an interior NVH detection algorithm, or a tire pressure measurement algorithm may require the vehicle to be moving to function). The pruned tree may then be used to select the ideal algorithm or model with the most-specific match between the training data and the current operating context.

In some examples, with complicated vehicle operating contexts, and with systems measured under uncertainty, binary states may not be sufficient to describe the system status. For this reason, a three-state or higher system, e.g., comprising values of −1, 0, and 1, may be used in some examples.

In some examples, if a context parameter is 1, it is true or the condition is met. If it is 0, it is false, or the condition is not met. If an identified context parameter is a negative value (−1) that means it is unnecessary for the diagnostic application, not available, uncertain, or not applicable (e.g. lateral acceleration is not applicable if a vehicle is stationary).

In some examples, these negative values may be removed from the input feature vector, and the corresponding element class may also be removed from the reference database. In this way, a nearest neighbor matching algorithm may ignore uncertain or unnecessary data in considering the model to be used for diagnostics or prognostics. This matching algorithm may need a distance metric, which are algorithm-specific weighting coefficients used to define the importance of each context parameter (e.g. state of the engine may be more important than the amount of longitudinal acceleration when diagnosing motor mount condition, assuming both parameters are known).

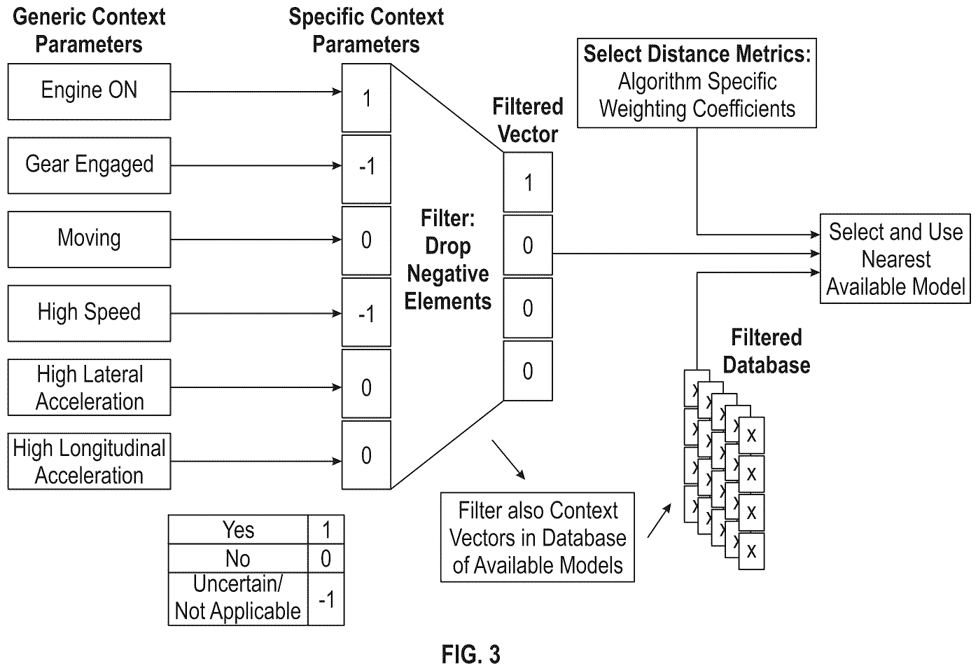

A visual overview of an example context identification and nearest-neighbor model selection process appears in FIG. 3 In some examples, the model selection process may rely on correct identification of both the vehicle variant and the context. FIG. 3 illustrates an example method for identifying the vehicle context and using those relevant features to select an appropriate “nearest neighbor” when identifying the optimal diagnostic or prognostic model to choose in accordance with an example. Context parameters may be identified through distinct, binary classifiers capable of reporting confidence metrics. In this example, the context vector may comprise entries with three possible states (yes/no/uncertain or irrelevant), and those uncertain or irrelevant entries and their corresponding matches in the reference database may be removed such that only confident, relevant parameters are used to select the nearest trained model.

Just as Bluetooth connectivity may be used to limit the plausible set of vehicle types, in some examples so too may data from sources such as on-board diagnostic systems be used to limit the set of feasible operating contexts, thereby removing uncertainty from the model selection process.

By combining vehicle identification with context classification, comprehensive vehicle “metadata” may be identified in some examples—for example, “light duty, 2.0 liter, turbocharged, Ford, Mustang, Joe's Mustang.” With the fullest possible context identified, a list of feasible diagnostic algorithms may then be shortlisted.

Certain diagnostics may be feasible for each set of vehicle classes and operating contexts. For example, if a vehicle is moving, only algorithms working for moving vehicles will be available. In another example, if a vehicle is at idle, only algorithms operating at engine idle will be available. In another example, if a vehicle is on a gravel road, only algorithms suitable for rough terrain will be offered.

When the off-board device identifies an appropriate context and short-lists feasible diagnostic algorithms, the most-specific diagnostic model of that type available with sufficient n of training vehicles may be chosen and run on the raw data or engineered features provided by the off-board device (and vehicle sensors, if available).

In some examples, these algorithms may initially start out coarse—is the engine normal or abnormal? Are the brakes normal or abnormal? In some examples, over time, as algorithms become more sensitive, and as training data are generated (with labeled or semi-supervised approaches), more classes may be added. In some examples, the disclosed system and method may transition from binary classification (good/bad), to gradation (80% remaining life, 10% worn), to diagnostics so sensitive that they in fact are prognostics—that is, algorithms sensitive enough that faults may be detected and addressed proactively.

The result may be improved efficiency, reliability, performance, and safety, and eased management of large-scale, high-utilization fleets, such as those that will be run by shared mobility services. In some examples, the algorithms or models used may over time be adapted to minimize a cost function, e.g. balancing user experience with maintenance cost with the likelihood of having a car break down on the road. This may supplant data-blind proactive scheduled maintenance with data-driven insights sensitive to use environment, risk tolerance and mission-criticality.

At block 114, it may be determined whether the context-specific model selection is complete. If the context-specific model selection is not complete, for example, there are additional features of the vehicle context to be analyzed to identify a diagnostic model, the process returns to block 112. For example, based on the example given above, a model may be chosen based on the context off whether the engine is on or off. Once it is determined whether the engine is on or off, a model may be selected based on whether, for example if it is on, the engine RPM. In some examples, the context determination and model selection process may be performed sequentially. In some examples, the context determination and model selection process may be performed at the same time. In some examples, when the context determination and model selectin are done sequentially, each step the section or prediction may be based on all previous and subsequent features. At block 114, if the context-specific model-selectin is complete, the selected diagnostic or prognostic model may be applied at block 116. In some examples, the results of the application of the selected model(s) may be stored in, for example, data storage or memory of the off-board device. In some examples, the results of the application of the selected model(s) may be sued to generate a report or alert that may be provided to a user. For example, a report may be provided on a periodic basis or may be provided when an issue or problem is identified.

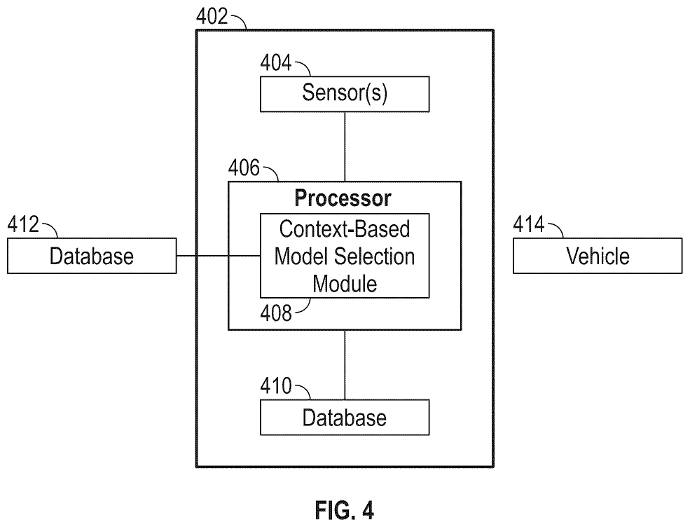

FIG. 4 is a block diagram of an example system for off-board diagnostics using a method for context-based diagnostic model selection in accordance with an example. The illustrated example in FIG. 4 is directed to an off-board device 402 (e.g., a mobile device, a wearable device, etc.) configured for diagnostic and condition monitoring using context-based diagnostic model selection for a vehicle 414. The off-board device 402, for example a smartphone, may include sensor(s) 404 and a processor 406 coupled to and in signal communication with the sensor(s) 404. The processor 406 may include a context-based diagnostic model selection module 408. The off-board device 402 may also include a database 410 that may be used to store a plurality of instance-specific models and context-specific models. The off-board device 402 may also be in signal communication (e.g., via a wired or wireless communication link) with an external database 412 that may also be used to store a plurality of instance-specific models and context-specific models. The external or remote database may be stored on, for example, another computer system or server. In some examples, models that are accessed more frequently by the processor 406 may be stored in the database 410 on the off-board device and models that are access less frequently by the processor 406 may be stored in the external database 412 and accessed and retrieved by the processor 406 when needed. In some examples, the sensor(s) may include vibroacoustic sensors, such as a microphone and an accelerometer, or other ambient sensing devices. In some examples, the off-board device 402 may also be in wireless communication with the vehicle 414 (e.g., via a Bluetooth connection) to access data directly from the vehicle 414.

Examples of example classification systems that may be used to identify critical vehicle powertrain parameters useful for automated model selection through the creation of a flexible and user-friendly framework for testing varied featured generation and classification approaches. Feature extraction, machine learning, software framework, and results may be performed for different categories including engine aspiration, fuel type, and cylinder count. These labels may be predicted sequentially in order to exploit potential correlation, leading to a ROC-AUC higher than 93% for the measured parameters in many cases.

In the various examples and examples samples of varied engines were may recorded from known examples from, for example, workshops, and from video clips of idling vehicles. Samples were captured variously from under hood, near a closed hood, and near the vehicle's exhaust. In these examples, data were manually labeled and in the case of uncertainty, labels were not assigned. Class balance was impacted by limited data availability, particularly reflecting a small number of “Vee” engines and low cylinder-count engines, though trends broadly reflected the imbalanced nature of real-world powertrain diversity.

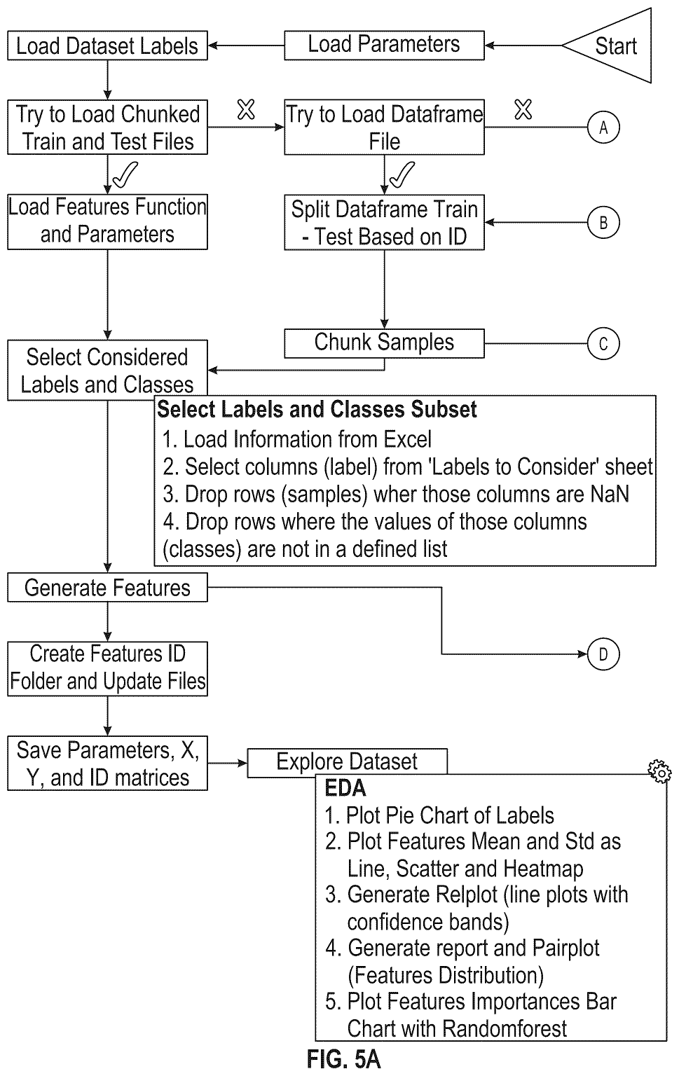

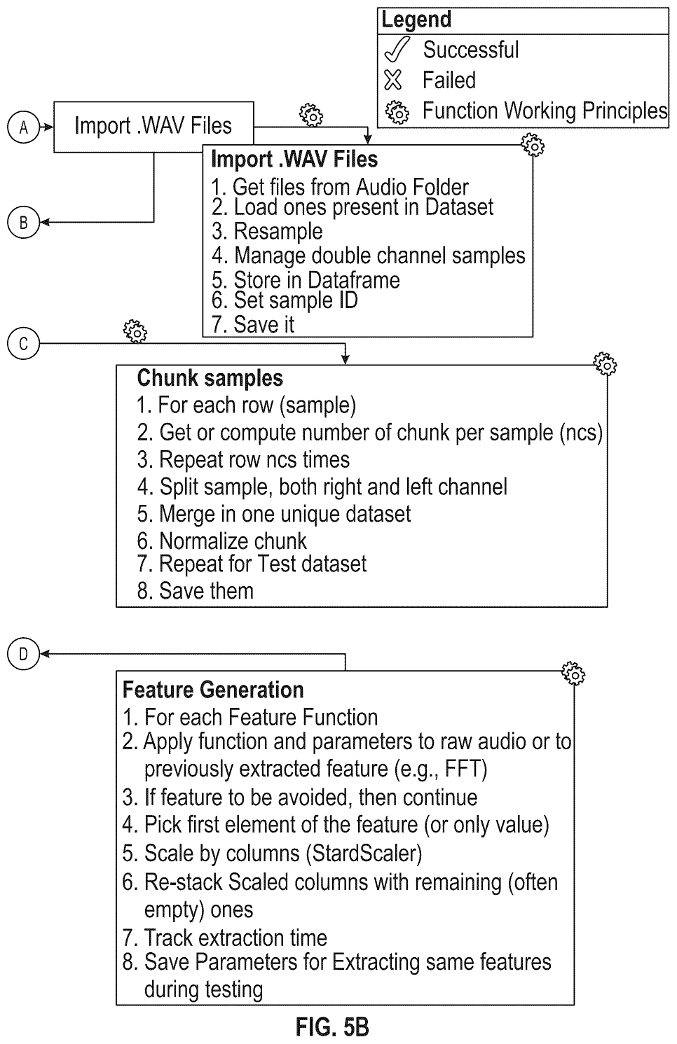

In some examples, a Python clip randomizer and feature extraction framework was developed to provide input into diverse classification models. A framework was created to support the generation of similar features including Fourier Coefficients, Mel-Frequency Cepstral Coefficients, and Discrete Wavelet Transform (DWT) features. These parameters may capture critical waveform details that might be discernible to the human ear. In addition to these features, additional data such as skewness, kurtosis, power spectral density, and zero-crossing may also be included to provide additional differentiating power. For each feature, the example framework allowed for rapid configuration of feature parameters to aid in conducting a comprehensive grid search to find the globally-optimal model. Based on the results from exploratory data analysis, hypotheses were identified for testing within various classifiers. An example data split and feature generation approach are shown in FIGS. 5A and 5B. FIGS. 5A and 5B illustrates an example process by which captured engine audio is split into a set of informative features, as well as exploratory data analysis used to inform classifier design in accordance with an example.

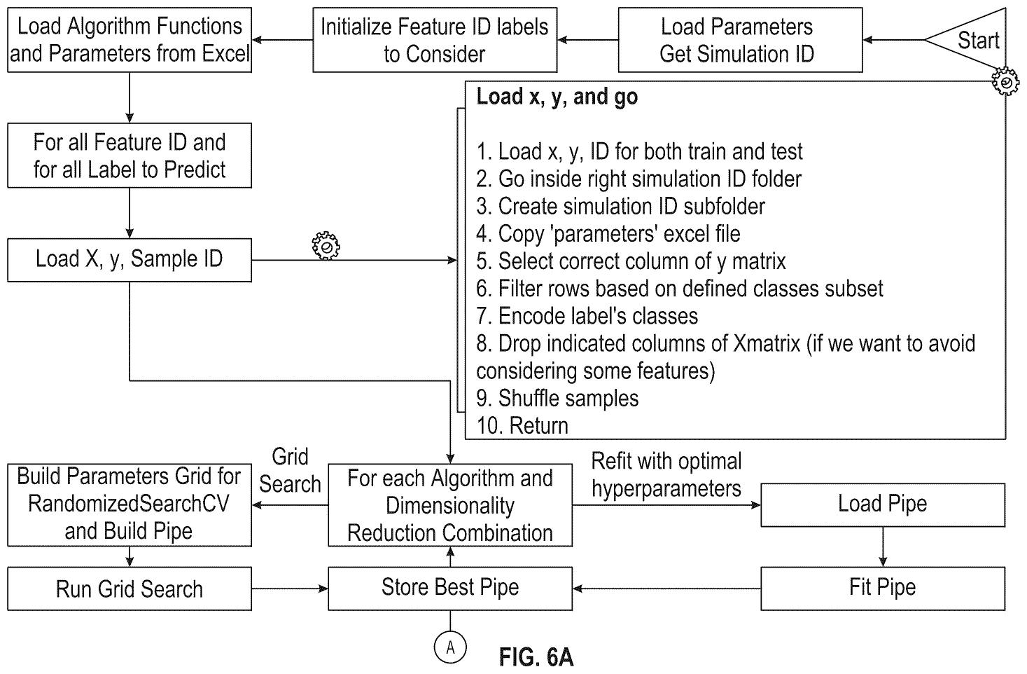

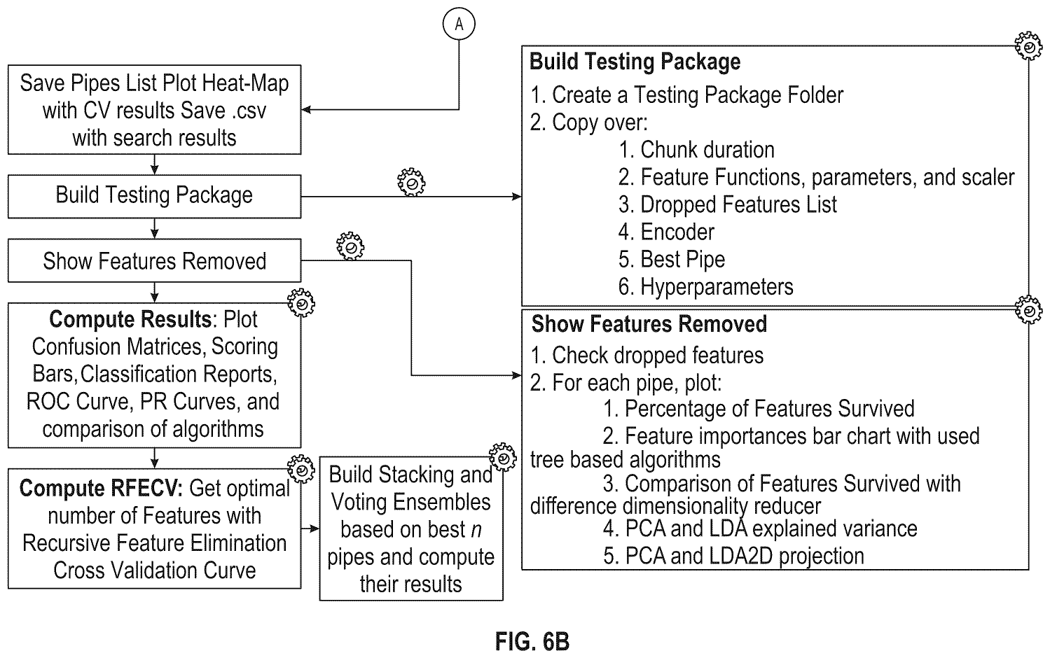

From the generated features, the examples described are implemented software to conduct a grid search over classifier models and hyperparameters, the flow of which is shown in FIGS. 6A and 6B. FIGS. 6A and 6B illustrates an example process through which feature sets are loaded in order to test varied classification models in accordance with an example.

In the examples, the first several context layers may be assumed—in this case, that the system is a light-duty vehicle, that and that it is idling. Aspiration type, fuel, and cylinder count may then be classified as a means of working towards increasingly-specific diagnostic model selection. The ordering of this example varies slightly to that described above with respect to FIGS. 1-3 and was determined based on apparent correlation among the sample dataset; in some examples, the optimal ordering may be determined based on the available input data.

From an exhaustive search, satisfactory performance for aspiration classification may be found using an ExtraTrees classifier with Random Forest as a feature dimensionality reducer with the Receiver Operating Characteristic (ROC) Area Under the Curve (ROC-AUC)=0.82 and the Precision-Recall Area Under the Curve (PR-AUC)=0.8, with the confusion matrix in Table 1. In the examples, the classification result was dominated by Fast Fourier Transform (FFT) features, with some informative Mel-Frequency Cepstrum Coefficient (MFCC) features.

TABLE 1
This Confusion Matrix shows the results for the aspiration-type
classifier described in Appendix A, which used an ExtraTrees
classifier with Random Forest as a feature dimensionality reducer
to classify based primarily upon FFT and MFCC features.

| | Normally Aspirated | Turbocharged |
|---|---|---|
| Normally Aspirated | 0.72 | 0.09 |
| Turbocharged | 0.28 | 0.91 |

Similarly, in some examples a fuel type classifier may be developed using a grid search approach. In this example, aspiration status may be used as an additional feature in determining fuel type. In this example, Gradient Boosting is the most-effective classifier, using FFT meta-statistics as input. In this example attained ROC-AUC (0.99) and PR-AUC (0.994), with the confusion matrix shown in Table 2. Note that these results are for a single audio segment; if multiple segments are averaged and used to vote on the final classification; results improve further.

TABLE 2
This Confusion Matrix show s the results for the example fuel
classifier described in Appendix A, which used Gradient Boosting
to classify primarily based on FFT meta-statistic features.

| | Diesel | Gasoline |
|---|---|---|
| Diesel | 0.93 | 0.05 |
| Gasoline | 0.07 | 0.95 |

Cylinder count may be considered as the next and most-specific level of context for use in model selection within the framework example. This level of context classification may entail multi-class labels and may suffer from class imbalance. While region-specific models may improve performance by excluding uncommon labels, broader models struggle to attain satisfactory performance.

In the worst-case model, in which all available labels are represented, the example found that using gradient boosting as a feature reducer and XGBoost as a classifier yielded the best performance, with a ROC-AUC=0.93 and PR-AUC=0.856. The confusion matrix appears in Table 3.

TABLE 3
This Confusion Matrix shows the results for the worst-
performing, broadest cylinder count classifier.

| | 3 | 4 | 6 | 8 |
|---|---|---|---|---|
| | Cylinder | Cylinder | Cylinder | Cylinder |
| 3 Cylinder | 0.5 | 0.0072 | 0.24 | 0 |
| 4 Cylinder | 0 | 0.82 | 0.5 | 0.33 |
| 6 Cylinder | 0.5 | 0.072 | 0.12 | 0 |
| 8 Cylinder | 0 | 0.099 | 0.14 | 0.67 |

Based on the strong per-parameter classification results for these three contextual classifiers, it is clear to see the feasibility in developing a suite of algorithms for determining a vehicle's use and operating context and how such data may be used as features in selecting an appropriate diagnostic model, whether for condition monitoring, or fault detection or analysis. With such a framework in place, it becomes feasible to select specific or generalized diagnostic algorithms based on the confidence of contextual classification and the availability of variously-tailored diagnostics.

In some examples, context-specific models tailored to a single engine variant may demonstrate enhanced performance over a 15-vehicle trained generalized on the order of approximately 10%, and better than a model trained on six vehicles with a similar engine configuration by approximately 5%.

In some examples, the data used were from varied, uncalibrated devices. While calibration may be necessary in some examples to attain quantitative, rather than qualitative, results, it may not be necessary in some examples when using appropriately pre-processed data to differentiate among vehicle configurations.

The systems and methods described herein paint a bold picture for the future related to transitioning on-board diagnostic systems into off-board, consumer-owned devices with the potential to upgrade both software and hardware over time. In addition, the systems and methods described herein may be designed to revolutionize automotive diagnostics and maintenance, particularly, for example, for ride-share companies already reliant upon mobile applications for driver accessibility and vehicle tracking.

As part of a mobile application, in some example customers may report data about vehicle health back to the fleet manager, and their phone may be used to collect data and to pay for the bandwidth of the logger. Beyond mobile devices, vibroacoustic diagnostics may be built into, for example, garage door openers, service stations, or parking lots.

In some examples, the disclosed systems and methods for context-based model selection may utilize diagnostic results in conjunction with emerging technologies such as augmented and virtual reality and 3D printing to guide component inspection, maintenance, production, and replacement, with AR helping walk untrained users through component inspection, testing, and replacement, even guiding them through validating diagnoses. The same mobile devices used for diagnostics may then be used to access Augmented and Virtual Reality visualizations of components and their wear states or fault conditions. Connected vehicle services may be used to automate repair and maintenance scheduling, to minimize downtime for shared fleets.

While the present disclosure describes examples and examples in the automotive field, the systems and method for context-based diagnostic model selection may also be used in other technological fields. For example, the concept of pervasive sensing diagnostics (e.g., using vibroacoustics, time series current data, etc.) may extend more broadly into “universal diagnostics,” wherein the same techniques discussed herein may be used for ubiquitous sensing of other device and system types and classes. For example, appliances including washing machines and microwaves may be monitored as well as cars, trucks, motorcycles, and bicycles.

The present disclosure describes a multi-step framework to pick hyper-specialized models based on device type and use context. In some examples, vibroacoustic analysis may be applied across the automotive life-cycle, from monitoring production equipment to measuring process outputs to estimating (and automatically improving) the condition of automotive subsystems.

In some examples, vibroacoustic signals may be used to diagnose faults in other electromechanical systems, such as power tools and coffee grinders. In some examples, similar techniques may help instrument people, diagnosing, for example, early-onset Parkinson's disease.

Combining pervasive sensing with enhanced diagnostics and embodied intelligence—that is, the ability for an application to bring expert knowledge to non-expert users—has the potential to change the world well beyond computer science, revolutionizing mechanical, chemical, and electric engineering, materials, science, and beyond.

In additional examples contemplated hereunder, two alternative approaches for achieving vibroacoustic assessment of an engine are provided which utilize deep learning. One approach can be thought of as implementing a ‘Cascading’ classification approach via one or more deep learning networks, wherein the output of one network is utilized as an input to another network. The other approach can be thought of as implementing a ‘Parallel’ classification approach via a single deep learning network. Though, as described below, this could in practice be implemented in several ways that accomplish the same general construction.

### Cascading Deep Learning Implementation

In Cascading examples for vibroaccoustic vehicle diagnostics, the processes for classifying and characterizing an engine initially described above can be modified such that a novel cascading architecture can be implemented. For example, in some examples a cascading architecture may be implemented as a multi-level, sequential, conditional neural network that makes multiple predictions and cascades each prediction to one or more successive layers of the network. Such a network can integrate multiple highly-granular classification tasks such that the output of each task may inform successive tasks. In other words, a Cascading architecture can be thought of as a multi-level, sequential, conditional network that makes multiple predictions and cascades some or all of such predictions to successive layers of the network.

Examples of Cascading architectures (as will be described below further) can focus on multiple low-level, fine-grained multi-level label predictions with the assumption of the highest-level class, rather than simply classifying a single level at a time. Given the Cascading approach can focus on these fine-grained tasks, the approach does not need to utilize general acoustic embeddings but rather lightweight models trained from scratch. Additionally, the Cascading approach can be implemented so as to utilize data collected at a higher sampling rate (48 kHz) compared to that collected from public sources (such as YouTube, which sources can cap sampling rate and in the process may discard useful informative features that may have provided useful insights in training). Thus, models trained on publicly available audio sample repositories (e.g., crowd-sourced audio from phones in vehicles) may not perform as well as models trained and operated using raw, full-frequency audio directly collected from a mobile device. Publicly-available sources also conduct feature-destructive compression on some audio samples, which can limit model performance and generalizability. Thus, the approaches described herein use larger frequency ranges to provide detailed classification lower into the stack.

In one experiment performed by the inventors, a system was implemented using a cascading architecture constructed as a two-stage convolutional neural network (CNN) with a first stage specializing in vehicle attributes which cascaded its attribute predictions to a second stage which classified input signals as having a specific fault condition (e.g., misfire fault). The following disclosure will describe such a system in detail, then expand upon how such a system could be modified (e.g., to have different, more, or fewer input types; to detect more types of fault conditions or other such conditions of an engine; to be deployed via different hardware implementation; etc.).

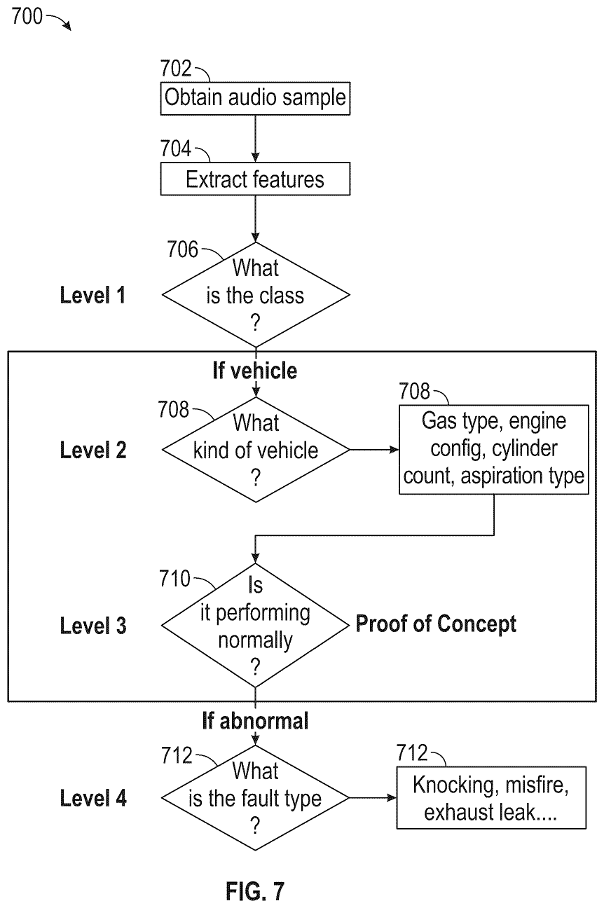

Referring now to FIG. 7, a conceptual flowchart illustrating how a cascading network could perform is shown. In some examples, the process 700 may be carried out by an on-board or off-board device 402 illustrated in FIG. 4. However, it should be understood that the process 700 may be carried out by any suitable apparatus or means for carrying out the functions or algorithm described below. Additionally, although the steps of the flowchart 700 are presented in a sequential manner, in some examples, one or more of the steps may be performed in a different order than presented, in parallel with another step, or bypassed.

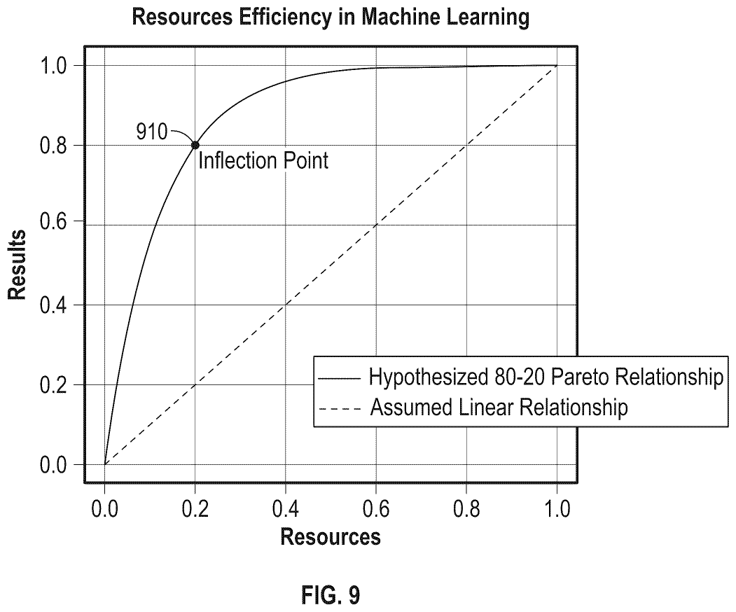

The Cascading network integrates multiple highly-granular classification tasks, and the result of each successive classification task can be used in the next classification task. Here, the Cascading network can have four distinct layers: 1) general acoustic classification (does the audio sample contain a vehicle), 2) attribute recognition (what is the kind of vehicle?), 3) status prediction (is the vehicle performing normally), and 4) fault identification (if abnormal, what fault is occurring?). The Cascading network can complete these tasks simultaneously in a unified deep neural network architecture. The Cascading network architecture can use multi-level, sequential, and conditional networks as shown in FIG. 7. At step 702, audio samples can be obtained. For example, the audio samples can include raw samples (e.g., a waveform). In some examples, the audio samples can be obtained using off-board devices (e.g., mobile phones or any suitable device to record sound from a vehicle). For example, the mobile phone microphone can record audio samples, which tend to have repeatable characteristics within the range of frequency similar to those of human speech and hearing (roughly 20 Hz-20 kHz). However, it should be appreciated that the microphone is not limited to the microphone in the mobile devices. For example, the microphone can be any suitable condenser (e.g., DC-biased condenser, RF condenser, electret condenser, valve microphone, dynamic microphone, piezo microphone, etc.) to record sound from the vehicle. It should be understood that the audio sample can be obtained using on-board devices with capability to record sound occurring in the vehicle. In further examples, the audio samples can be split into pre-determined second clips (e.g., 1, 1.5, 2, 2.4, 3, or any other suitable time-length clips). However, it should be appreciated that the audio samples can be dynamically split into clips with various time length. The pre-determined second can be any suitable seconds to provide features and models with a standard input size for training and be short enough that would allow for clips within the same sample to be distinct and useful for training. In even further examples, the audio samples can be augmented for training the Cascading neural networks based on different augmentation parameters (e.g., change volume between −5.0 and 5.0, pitch shift between −0.25 and 0.25, change speed between 0.92 and 1.08, and background noise addition with signal to noise ratio (SNR) between 0.05 and 0.20, etc.). In a non-limiting scenario, the audio samples can utilize a 48 kHz sampling rate, for which frequencies ≤24 kHz are considered according to the Nyquist-Shannon Sampling Theorem. These samples were collected using a stereo microphone for which the dual channel input is averaged into a single mono channel. Each sample was split into 3 second chunks which resulted in a 1×72; 000 input vector for the raw waveform. The audio samples may be a reduced set of audio sample data. As is described in detail in FIGS. 9-17, a reduction in the amount of audio data may be performed in various ways while still providing accurate results.

At step 704, audio features can be extracted from the audio sample. In some examples, an audio feature can include the raw sample (e.g., vibroacoustic data) itself. The waveform may include time domain information. In other examples, the audio feature may include Fast Fourier Transform (FFT), which transform the waveform from the time domain to the frequency domain. Thus, the FFT can provide the model with frequency information. In further examples, the audio feature can include Mel-frequency Cepstral Coefficients (MFCCs), spectrograms, or wavelets. MFCCs, spectrograms, and wavelets can provide the model with varying degrees of hybrid time and frequency information at different dimensionality. For example, the FFT, waveform, and wavelets can include 1D information, while spectrogram and MFCCs can include 2D information. It should be appreciated that the audio feature can include any other suitable feature extracted from an audio sample.

At step 706, whether a vehicle is contained in the extracted audio feature can be identified. In some examples, the vehicle can include a road vehicle (e.g., car). However, it should be appreciated that the vehicle can include any other suitable vehicles (e.g., water, road, rail, and air vehicles).

In some examples, steps 708 and 710 can be implemented using a two-stage neural network. An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network. Here, the first stage receives one or more of the previously described feature sets at step 704 as input while the second stage receives both the feature set and the attribute predictions from the first stage.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned to a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks, including more than, for example, three hidden layers may be considered deep neural networks.

The last hidden layer in the artificial neural network is connected to the output layer. Similar to the input layer, the output layer typically has the same number of nodes as the possible outputs. In an example in which the first stage of the two-stage artificial neural network, the output layer may include, for example, a number of different attributes, where each different node in each attribute corresponds to a different attribute prediction. In a non-limiting example, the output of the first stage of the two-stage artificial neural network can include four attributes (e.g., fuel type, engine configuration, cylinder count, and aspiration type). The fuel type attribute can include two nodes indicative of gasoline and diesel, respectively. The engine configuration attribute can include three nodes indicative of flat configuration, inline configuration, and Vee configuration, respectively. The cylinder count attribute six nodes indicative of 2, 3, 4, 5, 6, and 8, respectively. The aspiration type attribute can include two nodes indicative of normal aspiration and turbocharge aspiration, respectively. It should be appreciated that the types of attributes and the nodes in each attribute are mere examples and can be any other suitable attributes and nodes. In further examples, the output of the second stage of the two-stage artificial neural network may include, for example, a number of different nodes, where each different node corresponds to a different fault. For example, there could be two nodes indicative of a normal state and an abnormal state. In other examples, the nodes can include types of abnormal state (e.g., knocking, misfire, exhaust leaks, or any other faults).

During training, the artificial neural network receives the inputs (e.g., audio samples, features, etc.) for a training example and generates an output using the bias for each node, and the connections between each node and the corresponding weights. The artificial neural network then compares the generated output (e.g., predicted attributes of the first stage of the two-stage neural network, and fault detection of the second stage of the two-stage neural network) with the actual output of the training example. Based on the generated output and the actual output of the training example, the neural network changes the weights associated with each node connection. In some examples, the neural network also changes the weights associated with each node during training. The training continues until the training conditions are met. The training condition may correspond to, for example, a predetermined number of training examples being used, a minimum accuracy threshold being reached during training and validation, a predetermined number of validation iterations being completed, and the like. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

Different types of artificial neural networks can have different network architectures (e.g., number of layers, type of layers, ordering of layers, connections between layers, hyperparameters for layers). In some configurations, neural networks can be structured as a single-layer perceptron network, in which a single layer of output nodes is used, and inputs are fed directly to the outputs by a series of weights. In other configurations, neural networks can be structured as multilayer perceptron networks, in which the inputs are fed to one or more hidden layers before connecting to the output layer.

As one example, an artificial neural network can be configured as a feedforward network, in which the connections between nodes do not form any loops in the network. As another example, an artificial neural network can be configured as a recurrent neural network (“RNN”), in which connections between nodes are configured to allow for previous outputs to be used as inputs while having one or more hidden states, which in some instances may be referred to as a memory of the RNN. RNNs are advantageous for processing time-series or sequential data. Examples of RNNs include long-short term memory (“LSTM”) networks, networks based on or using gated recurrent units (“GRUs”), or the like.

Artificial neural networks can be structured with different connections between layers. In some instances, the layers are fully connected, in which each all of the inputs in one layer are connected to each of the outputs of the previous layer. Additionally or alternatively, neural networks can be structured with trimmed connectivity between some or all layers, such as by using skip connections, dropouts, or the like. In skip connections, the output from one layer jumps forward two or more layers in addition to, or in lieu of, being input to the next layer in the network. An example class of neural networks that implement skip connections are residual neural networks, such as ResNet. In a dropout layer, nodes are randomly dropped out (e.g., by not passing their output on to the next layer) according to a predetermined dropout rate.

In some examples, an artificial neural network can be configured as a convolutional neural network (“CNN”), in which the network architecture includes one or more convolutional layers. For example, the two-stage neural network can include two distinct multi-layer convolutional neural network (CNN). While the first stage shown at step 708 predicts one or more attributes of the vehicle, the second stage at step 710 can detect a fault (e.g., misfire) based on the cascaded attribute predictions. In an experiment, the Cascading model achieved 95.6%, 93.7%, 94.0%, and 92.8% validation accuracy on attributes (fuel type, engine configuration, cylinder count, aspiration type, respectively). The Cascading CNN also achieved 93.6% misfire fault validation accuracy. In some examples, audio features can be grouped into 1D (FFT, waveform, wavelets) and 2D (spectrogram, MFCCs) sets, with two distinct model architectures that utilize 1D and 2D convolution, respectively. In further examples, the MS architecture can be built for general audio classification using the raw waveform. General audio classification seeks to understand the high-level class of an acoustic sample such as speech, music, animal, vehicle, etc. This is a challenging task since general audio classification classes can range from tens to hundreds of distinct and unique labels. The unique aspect of the MS model utilizes a large convolutional kernel size of 80 in the first layer to propagate a large receptive field through the network. In some examples, the kernel size of 3 can be used for the remaining three convolutional layers.

For the MFCC model, the inventors utilize kernel size of 2×2 since 13 MFCC coefficients were chosen as a hyperparameter which results in an input dimensionality of 130×13. For the spectrogram, hyperparameters of 512 for hop length and 2048 for window size were chosen. This results in an input dimensionality of 1025×282. Since it was a larger input dimension than the MFCCs, traditional 3×3 kernels can be used for spectrogram.

For the 2D models, the two-stage neural network consists of three convolution layers, rather than four layers for the 1D models because of their smaller input width. In some examples, the precedent set can be followed, including pooling, batchnorm, and ReLU after each conv layer in 365 both 1D and 2D models. Also, dropout can be added with probability=0.5 after each layer to improve generalizability and to minimize the likelihood of overfitting. Each prediction task can be treated as classification and therefore final fully connected output layers can be obtained with dimensionality corresponding to the number of classes for each task. These predictions are then fed into log softmax and trained using negative log-likelihood loss.

At step 708 as the first stage of the neural network described above, one or more attributes of the vehicle can be determined based on the audio feature. For example, the one
or more attributes can include, but is not limited to, fuel type (e.g., gasoline or diesel), engine configuration (e.g., flag, inline, or V), cylinder count (4, 6, 8), or engine aspiration. However, it should be appreciated that the one or more attributes are not limited to the list above. For example, the one or more attributes can further include engine state (accelerating, idling, starting), make/model/OEM, horsepower, etc. In some examples, the attributes can be recognized based on the periodic acoustic emissions of rotating assemblies in the vehicle.

At step 710 as the second stage of the neural network described above, based on the extracted audio feature and the attributes, a status of the vehicle can be predicted. For example, whether the vehicle performs normally can be predicted.

At step 712 as the second stage of the neural network described above, the abnormal status (e.g., knocking, misfire, exhaust leaks, etc) can be detected if the vehicle status is abnormal.

### Parallel Deep Learning Architecture

In Parallel examples, steps 802, 804, and 806 are substantially the same as steps 702, 704, and 706 in connection with FIG. 7, respectively.

Steps 808, 810, and 812 are also similar to steps 708, 710, and 712, in connection with FIG. 7, respectively. Unlike the Cascading model, the Parallel model combines steps 808 and 810 in parallel. Thus, extracted features in step 806 can be inputs to the Parallel network (e.g., CNN), and the Parallel network uses a shared representation for both the attributes and state predictions.

While the Cascading model can include a two-stage CNN, the Parallel model can include a single stage CNN. Both models can perform the same prediction tasks: attribute recognition and status prediction. Additionally, both models can use the same MS backbone CNN architecture. This architecture includes 3-4 convolutional layers, each of which is followed by ReLU activation, batch normalization, max pooling, and dropout. The convolutional kernel type and size may vary based on the input feature. For 1D features FFT, wavelets, and the raw waveform, 1D convolution can be used throughout with a kernel size of 80 in layer 1 followed by 3×3 kernels in the remaining layers. For 2D features MFCC and spectrogram, 2D convolution can be utilized. For the smaller dimension MFCC features, 2×2 kernels can be used for 3 convolutional layers. For the larger dimension spectrogram features, 3×3 kernels can be used for 4 convolutional layers. One difference between the Cascading and Parallel models includes the location of the fully connected output layers. For example, for the Cascading model, the attributes output layer can be at the end of the stage one CNN and the misfire output layer can be at the end of stage two CNN. Additionally, the input to the second stage CNN can include the predicted attributes and original input concatenated. For the Parallel model, since there is only one stage, both the attributes and misfire output layers can be at the end of stage one. There is novelty in both models in that the Cascading model showcases whether two stages are desirable where each stage can specialize on the attributes and misfire tasks, respectively. Additionally, the Cascading model can show the value of fusing the input features with additional “noisy” data (i.e., predicted attributes) for the second stage CNN focused on misfire. The Parallel model demonstrating a single stage and shared representation can achieve similar performance on attribute recognition while utilizing fewer overall parameters.

### Audio Sample Processing for Diagnostics

While several sensing modalities can be utilized for diagnostics, sound is an efficient, easy-to-use, and cost-effective means of capturing informative mechanical data, e.g. by using audio captured with a smartphone or other audio or vibration capturing sensor, to identify fault or wear states. In some examples, audio and vibration data may be captured using a microphone, in other examples this data may be captured using a motion sensor, such as an accelerometer, and in further examples, vibration and (indications of) audio may be captured via video capture. In the examples described above, sound data was captured using microphones.

Compared with images, video, and other high-volume information, sound, like acceleration, is densely informative and compact. As a result, sound can be efficiently processed in near real-time by low-cost hardware such as embedded devices. Audio is particularly useful for providing insight into systems with periodic acoustic emissions, such as the rotating assemblies commonly found in vehicles and other heavy and industrial equipment. These data enable the identification and characterization of system attributes as well as fault diagnosis and preventive maintenance. This problem, however, is non-trivial and presents unique engineering challenges.

When characterizing an audio signal, the first feature explored is the raw sample itself, known as a waveform. This waveform provides standalone insights, though research has shown that feature extraction and transformation is a crucial step in building successful models in some acoustic recognition tasks. Transforming the raw waveform from the time domain to the frequency domain with the Fast Fourier Transform (FFT) provides particularly informative features. Other informative feature types utilize hybrid time and frequency information, such as Mel-Frequency Cepstral Coefficients (MFCCs), spectrograms, and wavelets. This characteristic similarly makes algorithmic differentiation an easier task.

As noted above, raw audio (rather than compressed or other lossy audio from public repositories) in a wide frequency range is utilized for increased accuracy in some examples. However, large numbers of samples (for training, validation, testing, re-tuning, etc.) are not always widely available for any given combination of vehicle/engine/cylinder/aspiration type/tires/etc. Therefore, m some examples the inventors have utilized a data pre-processing and augmentation method on available raw audio (wide frequency, more data-rich) samples to increase the amount of data available to develop the Cascading and Parallel approaches described above.

First, samples of raw audio are acquired and labeled (e.g., by vehicle make/model/year, engine type, engine cylinders, transmission type, aspiration type, size/type of tires, etc.). This may be done by use of mobile devices or other sensors in vehicles. For example, in some examples a vehicle manufacturer may acquire audio of vehicle types at manufacturing time (presumably when no or few fault conditions might exist) and may utilize a network of dealerships and mechanics to record audio of vehicles with fault issues. In other examples, vehicles may have on-board sensors which record acoustic data, that can be labeled according to vehicle VIN number and fault codes determined at service visits. In yet other examples, vehicle owners may contribute audio recordings acquired from mobile device applications on a voluntary basis.

The audio samples may then be split into uniform clip size and organized by label, so as to provide more homogenous input to the neural networks. In one example, the inventors split raw audio recordings into 3 second chunks, though other durations of clips are contemplated such as 1 second, 5 seconds, ten seconds, thirty seconds, etc.

Next, some or all of the audio clips may undergo an augmentation process. This may include such techniques as pitch shift, volume shift, speed change, and addition of background information. In some examples, a system may be employed that manages data distribution by label classification: in other words, audio samples of comparatively rare combinations of attributions (e.g., a rare fault condition, in a diesel engine or other less common engine) can undergo data augmentation (or more data augmentation) than samples of comparatively common combinations of attributes. In other examples, all data samples can undergo data augmentation. The degree of certain types of data augmentation may be set to correspond with limits or expected values associated with each vehicle type. For example, augmentation parameters can be set so as to line up with typical variation in engine configurations, e.g. through manufacturing diversity and wear. For example, frequency shift can be bounded based on typical allowable tolerances for idle speed. Amplitude limits can be set so as to minimize the effect of signal clipping.

Next, the set of clips resulting from the splitting and augmentation processes can be further processed by converting into multiple data types. In some examples, the raw, split, augmented data clips can be converted in one or all of several manners: Fast Fourier Transform (FFT), Mel-frequency Cepstral Coefficients (MFCCs), Spectrograms, and Wavelets. Converting into these features can give neural network models (whether Cascading or Parallel) a diverse set of inputs. The raw waveform provides the model with time information, while the FFT provides the model with frequency information. MFCCs, Spectrograms, and Wavelets provide the model with varying degrees of hybrid time and frequency information at different dimensionality.

### Example Implementations

The techniques and algorithms described above may be implemented via a variety of system arrangements, to be deployed via equipment operated by manufacturers, vehicle/equipment owners, mechanics or service providers, etc.

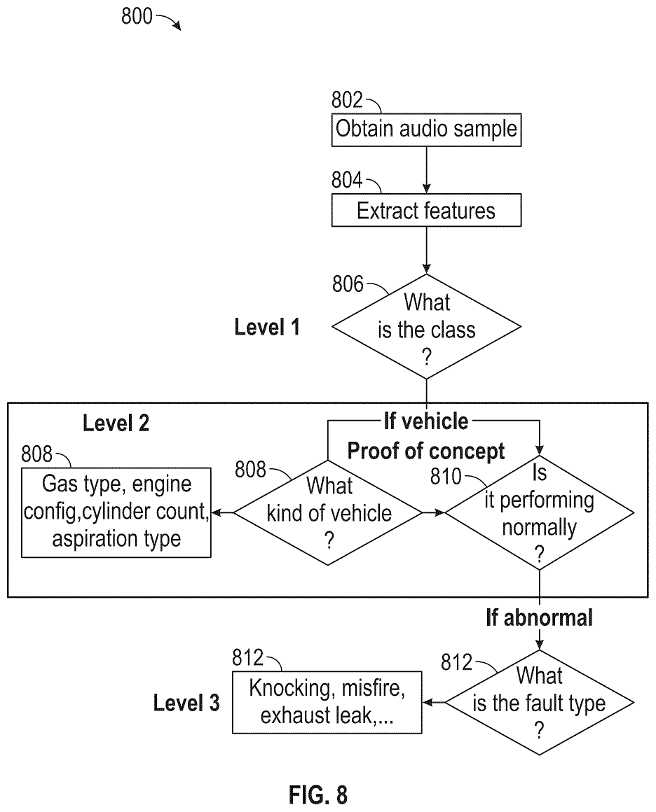

For example, the Cascading model and the Parallel model shown in FIGS. 7 and 8 are demonstrated on cars. However, it should be appreciated that the Cascading approach and the Parallel approach can be used in other vehicles, for other engine or industrial applications, or other suitable areas. For example, the Cascading approach can be used for applications where there is potential for inter-label dependency. For example, some systems that may utilize inter-label dependency in audio processing tasks may include music recognition—music recognition can involve hierarchies and label dependency, such as in a first stage determining (via a neural network for first stage of a neural network) ‘does the sample contain music?.’ Then a subsequent network or stage can be conditional upon the first stage, such that it could look to predict genre, artist, song, etc.

Not only can the Cascading architecture be extended to other audio applications, but also applications with other modes of data such as in computer vision. For example, biometrics could first ascertain whether a sample contains a valid fingerprint, iris, or facial scan. Then conditionally upon the first level, it could then ask whether the biometrics scan represents a valid user, what condition the user is in, perhaps using multi-modal data such as heart rate or blood pressure prediction. Another particularly relevant example in the larger vision field is autonomous vehicles (AVs). These systems are fusing many modes of data from sensors and making certain the state of the AV would be crucial. A Cascading neural network approach could follow a similar hierarchy as noted above: first, does a sample contain an AV, what are the attributes of the AV, is the AV behaving normally, and if not, what fault behavior is the AV? The sample may comprise an image or video sample (which could, e.g., be from a traffic light, security camera, drone, etc. which is monitoring vehicle movement/traffic, or from the AV itself), or may be multi-modal data including vibroacoustic data, image data, and other sensor outputs from the AV or remote sensors.

Another area for use of a Cascading architecture could be object recognition in images, such as animal recognition. For example, a sample may contain an image of an animal. A first network or stage of a network could determine whether the image contains an animal. Then, a subsequent stage or network could be conditional upon the first stage such that it could predict what kind of animal is in the image, what state the animal is in, what location the animal is in, whether the animal behaves normally, etc.

Another example application area for these techniques is broader fault identification, particularly using audio data. This can include other diagnostic areas, such as for industrial processes or energy sector equipment. One such example is home or industrial heating and ventilation systems: in this case, the first stage can be whether a sample contains ventilation equipment using acoustic classification networks. Then, the next stage can obtain its operating state and condition. If it's behaving normally, what is expected remaining useful life? If abnormal, what is the fault type and degree? For example, in some examples, a mobile application may be provided to a user for diagnostic use for an HVAC or other system. The application may provide information on the status of the equipment, as well as recommend various maintenance tasks be performed and/or replacement parts be purchased (e.g, new filters, cleaning, motor service, etc. can be recommended to the user).

This Cascading architecture can be extended to other applications where a mechanical fault might occur. Some of these may include home appliances (washer/dryer) with belt slipping or drum imbalance, electric cars/bicycles with suspension issues, manufacturing equipment (CNC mills/lathes) with tool run-out or spindle issues, drills with brush wear or belt slip, the energy sector with turbine and pump health, elevator/escalators condition, and even carnival/fair equipment. It should be appreciated that the Parallel approach can also be used in application areas described above.

In one example, a mobile app may be provided for user or mechanic usage, to diagnose status and fault conditions of a vehicle or other equipment. Software stored on the mobile device (or a remote server connecting to the mobile device) can provide a user interface that prompts the user to place the mobile device in a location where it can acquire audio and/or vibration data of the vehicle/equipment to undergo diagnostics. The software may then prompt the user to operate the vehicle/equipment in a number of states (e.g., starting, idle, acceleration, highway driving, etc.) that maximize the types of audio/vibration signals that will provide relevant information to the neural network. In other examples, the app may be granted permission to persistently acquire data whenever the user is in the vehicle and/or when a neural network detects the presence of vehicle audio. Once sufficient data has been acquired, the software may present a report of (1) remaining usable life of the vehicle and/or components of the vehicle (e.g., tire wear, filter life, etc.); (2) any likely fault conditions detected; and/or (3) recommendations for service, maintenance, and part replacement.

In another example, a diagnostic device may be provided that comprises a vibration sensor, microphone, and other sensors such as optical camera and multi-axis acceleration sensor. The device may be integrated into the vehicle/equipment itself, or sold as a kit or aftermarket device. The device may sense operation of the vehicle/equipment and transmit the raw data to a remote computing resource or may process the data via a neural network as described above and simply transmit results to a remote device such as a user's mobile device, user's email, or a manufacturer.

Various designs, implementations, and associated examples and evaluations of a system for precision conservation through reduction of greenhouse gas in agricultural operations are described above.

The present disclosure is a novel approach to addressing the challenges of data overabundance, sensor overprovisioning, and the high resource costs associated with traditional sensing systems and machine learning paradigms. This framework redefines how data are collected, processed, and utilized, particularly in resource-constrained environments where bandwidth, computation, storage, and energy are limited. At its core, the framework reduces data down to its most informative components by identifying and leveraging is called “Minimum Viable Data” (MVD). This concept reduces the volume and fidelity of data required to achieve desired outcomes, ensuring both efficiency and sustainability in machine learning applications while maintaining high performance. The reduction that may take place before capture. The reduction in the present disclosure may take many forms including but not limited to compression, choosing not to capture certain data, filtering and sub-selection, or combinations thereof.

Referring now to FIG. 9, the framework is driven by the hypothesis that there are common inflection points in the data quantity-quality spectrum, beyond which additional data offers diminishing returns in relation to resource expenditure. By identifying the inflection points, the framework establishes MVD parameters that enable diverse applications to meet their performance targets with minimal resource use. This approach not only lowers costs and reduces the environmental footprint of data-intensive operations but also democratizes access to AI technologies, making them feasible in resource-constrained settings.

The present disclosure is built around three objectives: (1) resource optimization which is to minimize the resources required for data collection, transmission, and processing while maintaining acceptable levels of machine learning performance; (2) sustainability which is to promote efficiency in Edge AI and IoT deployments by reducing energy consumption, network congestion, and the need for high-end hardware; and (3) accessibility which is to reduce barriers to entry for implementing AI solutions in environments where economic, energetic, and other resource constraints might otherwise preclude their adoption. Similarly, increasing the scale of deployments for a fixed resource budget. To meet these objectives, the framework employs the following methodology: (1) data characterization which is to qualitatively assess data factors to identify those characteristics most critical to performance and those amenable to reduction or simplification without significant loss of utility.

The method set forth herein is validated by conducting controlled experiments to empirically determine the MVD for various machine learning tasks, using metrics such as accuracy, precision, and recall as performance benchmarks. Generalization and application include extrapolating findings from specific case studies to broader applications, with a focus on generalizing the principles of MVD to a wide range of data types and machine learning paradigms.

Validating the present disclosure and Minimum Viable Data (MVD) through time-series audio data classification as a representative application domain. By experimenting with bit depth reduction, down sampling, and sample duration reduction, the resource constraints typical in sensor, bandwidth, processing, and power consumption scenarios and that impact both initial and operating cost are simulated. These experiments aim to generalize MVD through the Pareto Data Framework, offering validation for optimizing system design before sensor, network, and computing architecture deployment. By identifying inflection points in data quality and quantity, the performance outcomes can be predicted and informed resource allocation decisions may be made. This approach ensures systems are optimized not only for performance but also for cost-efficiency, accessibility, and sustainability in long-term applications. The objective is to identify permutable parameters relevant to resource utilization and to reduce them incrementally, mapping the performance degradation to pinpoint the “knee” or inflection point. This threshold reveals the minimum data quality and quantity needed before performance significantly declines, providing actionable insights for system optimization. As illustrated in FIG. 9, the inflection point 910 is referred to as an 80-20 inflection point in that the results continually improve for about 80 percent of the results but, after the inflection point 910, the effort being put in yields diminishing returns

Audio data such as from automotive systems as that described above presents both challenges and opportunities of data optimization in resource-constrained settings and is ubiquitous in Edge computing applications ranging from smart home devices to urban noise monitoring systems. The inherent characteristics of audio signals, such as their temporal structure and the wide range of frequencies, make them an ideal candidates for data reduction techniques like down sampling and quantization. Audio classification algorithms are sensitive to changes in sample rate, bit depth, and clip length. These properties make audio an ideal candidate for data reduction techniques that will scale to higher-dimensional signals. Further, the range of available microphones, from high-fidelity to lower-cost models, mirrors the quality-cost trade-offs faced in many real world deployments. Audio signals offer a robust framework for testing Pareto data principles and allow generalization to other time-series and high-dimensional data domains while leveraging our extensive experience in acoustic characterization.

To ensure comprehensive evaluation of the present disclosure, audio datasets that represent a range of real world applications were selected. Examples are provided below. Datasets with a higher number of classes reduce the likelihood of high performance due to random guessing. A larger class count also creates a greater margin of performance degradation as data quality and quantity are reduced. Additionally, datasets were selected to represent a range of data types, reflecting the variability encountered in different use cases of AI applications. This diversity enables us to test the generalizability of sensor optimization techniques across various real-world scenarios. The chosen four datasets span different data types and class counts to maximize generalizability:

The Environmental Sound Classification (ESC-50) dataset consists of 2,000 labeled audios across 50 classes of natural, human, and domestic sounds, offering a wide range of sound patterns and frequencies. It is ideal for evaluating how sensor optimization and data reduction techniques impact performance in diverse audio environments, such as environmental monitoring and smart cities, where noise and variability are prevalent. The GTZAN Music Genre Dataset contains 1,000 30-second of tracks across 10 music genres, recorded at 22,050 Hz mono in 16-bit resolution. This dataset helps assess how reduced data quality affects classification accuracy in complex and overlapping sound patterns, often encountered in entertainment and audio recognition systems. The Toronto Emotional Speech Set (TESS) provides 1,400 speech recordings depicting seven emotional states, offering a valuable resource for studying subtle variations in human speech/audio pattern under constrained data conditions, crucial for applications like emotional recognition and virtual assistants. The Audio MNIST dataset features 30,000 spoken digit samples from 60 different speakers, making it ideal for evaluating the framework's performance when reducing sample rate, bit depth, and clip length in basic voice recognition tasks. These datasets provide a comprehensive basis for testing and generalizing the concept and science behind the Pareto Data Framework.

To evaluate the Pareto Data Framework across different machine learning models, a variety of algorithms that balance resource efficiency and predictive performance were employed. Decision trees are well-known for their simplicity and interpretability, and they are versatile in handling both categorical and numerical data. The computational efficiency of decision trees is particularly beneficial in scenarios with reduced data, making them an attractive choice for resource constrained environments. Extending this approach, the ensemble learning method Random Forest, built upon decision trees, presents an avenue for enhanced predictive performance. Logistic Regression, a powerful yet computationally efficient algorithm, serves as a valuable baseline model, especially in resource-light scenarios or where interpretability is paramount. The simplicity and adaptability of KNearest Neighbors (KNN) make it well-suited for resource limited scenarios and has been effectively applied in analyzing data for predictive maintenance or for anomaly detection. Gradient Boosting models, exemplified by XGBoost or LightGBM, stand out as powerful ensemble methods capable of achieving high predictive performance even in the face of resource constraints. Additionally, certain neural network architectures, such as lightweight convolutional neural networks (CNNs) and shallow feedforward networks like MobileNet and SqueezeNet, are tailored for resource efficiency, catering to the demands of edge and mobile devices. Support Vector Machines (SVMs), recognized for their effectiveness in binary and multiclass classification tasks, excel in managing reduced data facets and efficiently handling high dimensional spaces, thereby striking a fair balance between predictive performance and resource usage. Testing with these algorithms will help to demonstrate the framework's flexibility and applicability across different machine learning paradigms, establishing its utility, relevance and applicability in real-world, resource-constrained environments.

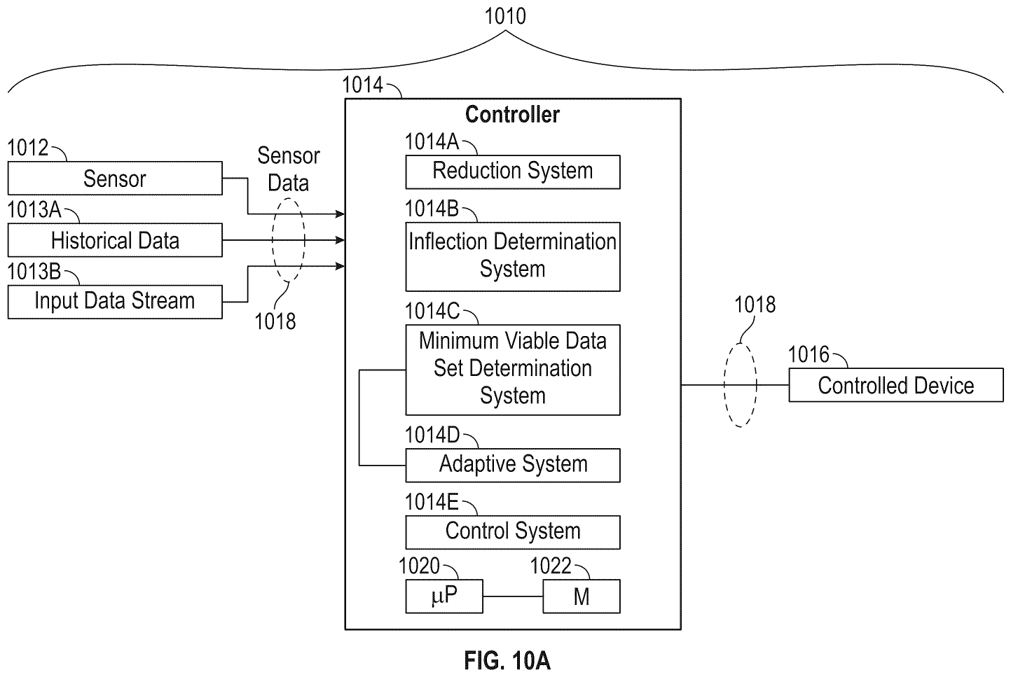

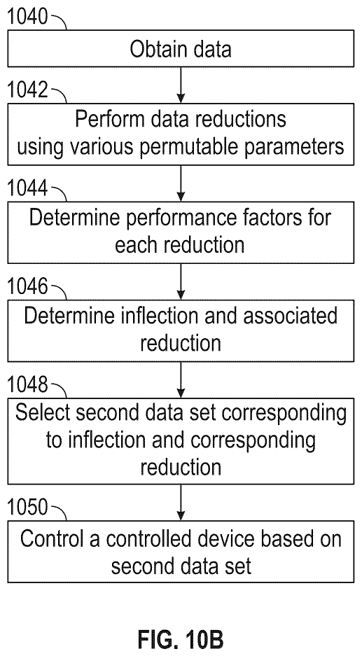

Referring now to FIG. 10A, to optimize for resource constraints such as bandwidth, storage, sensor quality and cost, and computation in constrained systems, data parameters are identified that directly and significantly impact resources and that are quantifiable with the potential for alteration or reduction. For audio data, sample rate, bit depth, and clip length were selected as being significant as these have clear, measurable effects on resource consumption. Lower sample rates reduce the frequency range captured, leading to smaller file sizes and lower bandwidth requirements, while bit depth affects the precision of each sample, directly correlating with data rates and storage. Clip length impacts the amount of data retained for classification and optimizing it can further reduce resource consumption. Other factors, such as the number of channels or coding formats, were considered less variable for reduction in this context.

In FIG. 10A, a high level representation of a system 1010 is set forth. The system 1010 may represent various types of systems including but not limited to an automotive vehicle (e.g., misfire detection, air intake), a machine tool (e.g., a hydraulic system, a CNC machine), a manufacturing system, an energy system (e.g., solar), a utility system (e.g., municipal water distribution), an agricultural machine, a logistics/warehouse or various other types of machines, some examples of which are described below. The system may include a sensor 1012 that communicates sensor data to a controller 1014. The sensor 1012 may be one of various types of sensors including an automotive sensor, a vibration sensor or a sound sensor. The sensor 1012 may be a plurality of sensors of the same or different types. The controller 1014 may be used for various purposes and include receiving historical data 1013A or an input data stream 1013B that has various types of data that originate from various types of sensors.

The controller 1014 is used for controlling various types of control devices 1016. It should be noted that the sensors 1012, the controller 1014 and the controller device 1016 may all be physically in one device. However, a network 1018 may be used to communicate remotely located sensors to the controller 1014 or communicate data or control signals to the control device 1016.

The controller 1014 may comprise a microprocessor or processor 1020 that is in communication with a memory 1022. The memory 1022 may be a non-transitory computer-readable medium including machine readable instructions that are executable by the processor 1020 and includes instructions for controlling the control device 1016.

The controller 1014 may include a reduction system 1014A that is used for processing the data from the sensor 1012, the historical data 1013A and the input data stream 1013B. The reduction system 1014A may use one or more different types of reductions on a particular dataset to form a plurality of reduced sets of data. More than one type of reduction may be used on a dataset. The reduction system 1014A may also determine an indicator of performance. That is, a performance factor for each type of reduction may be generated when the data is reduced. The performance factor may be one of but not limited to accuracy, damage reduction, better fuel economy, reduced down time, lower repair costs.

An inflection determination system 1014B may be used to determine an inflection or knee point for the data. As mentioned above, the inflection is a point of diminishing returns for the performance. That is, the performance may improve to a certain inflection point and any improvement results in wasted resources after such point. The inflection point may be an 80-20 Pareto type inflection point.

A minimum viable dataset determination system 1014C may be used to obtain the minimum dataset according to the inflection and corresponding to the reduction associated with the inflection point. The minimum viable dataset or second set of data is a reduced set of data with the reduction selected that corresponds to the inflection point or lower. During operation of a system, the inflection point may be determined once, or the inflection point may be adaptively determined as provided by the adaptive system 1014D. The adaptive system 1014D allows the data to vary over time and thus the inflection point may change over time using the teachings set forth above and described in more detail below with respect to the method. That is, predefined thresholds or learned parameters may be changed or adapted over time based upon past data that may be stored in the memory 1022, statistical models and machine learning. For example, an engine of a vehicle may change noise characteristics over time based upon the wear of certain portions of the cylinders such as the piston rings. Machine tools and other devices with motors or bearings may also change characteristics over time. The adaptive system 1014D takes into consideration the variations over time.

Ultimately, a reduced amount of dataset is used by a control system 1014E to generate control signals that are provided to the controlled device 1016. The control system 1014E within the controller 1014 may be an optional position.

Referring now to FIG. 10B, a high level flowchart of a method for operating a system is set forth. This high-level flow chart applies to all types of systems. A specific detailed mis-fire method is described in greater detail below. In step 1040, data is obtained as described above relative to FIG. 10A. That is, sensor data, historical data and an input data stream may be used as the input data alone or in combinations. In step 1042, data reductions may be performed using various permutable parameters. The data reductions may be performed using various types of data reductions including down sampling, quantization, combined sample rate in quantization and segmentation. This includes changing the sample rate and the depth. In step 1044, the performance factor for each different type of reduction apply is determined. The performance factor may be various types of factors including accuracy.

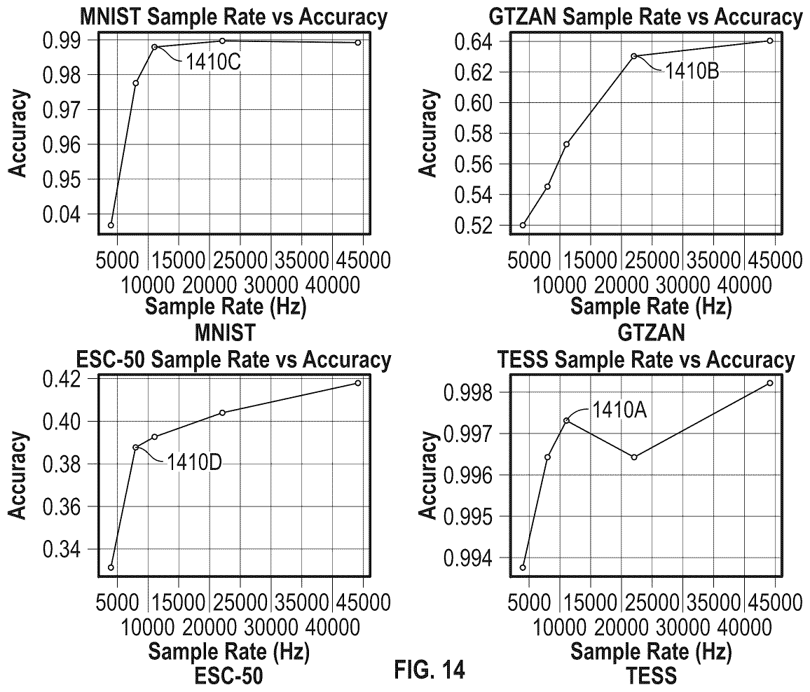

In step 1046, an inflection point is determined by processing the data. Visually this is illustrated in FIG. 9 and below in FIGS. 14-17 That is, the data may be plotted in graph form so that visualization of the inflection may be determined. In a controller this can be performed mathematically without the need for a visual plot. In a mathematical sense, the slope of the curve may change below a predetermine slope threshold.

In step 1048, a second set of data corresponding to the inflection and the corresponding reduction is selected. That is, the second dataset may be provided based on data already within the system or may be new data that is provided from a sensor over time using the reduction determined in step 1046. The second set of data is a reduced set that may be obtained without storing or receiving all the data available from the sensors.

In step 1050, a control signal may be generated at the controller or at the control device to control the control device based upon the second dataset.

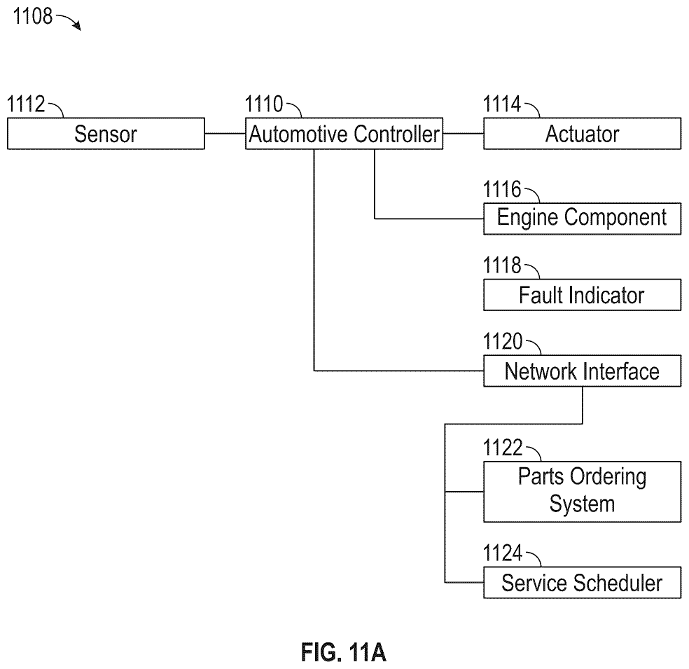

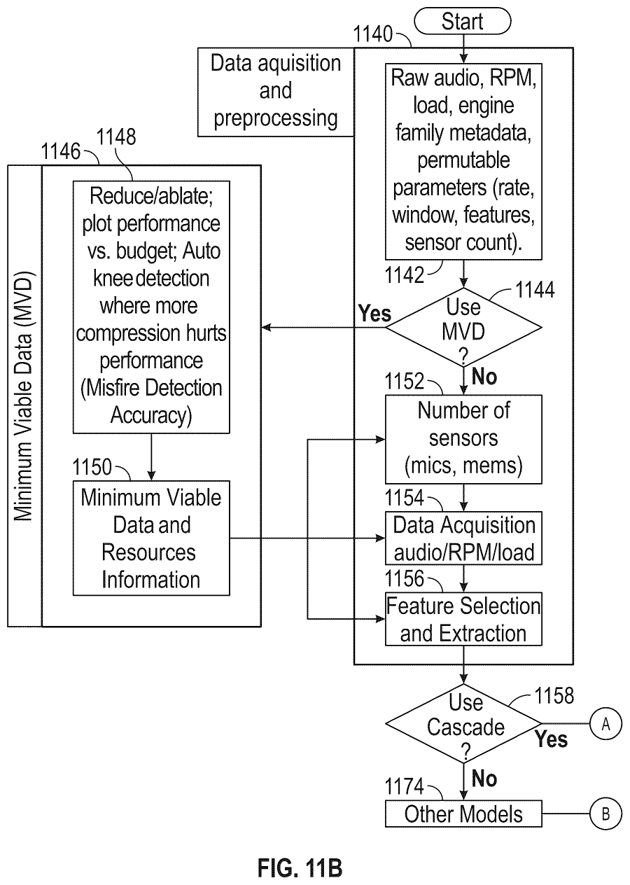

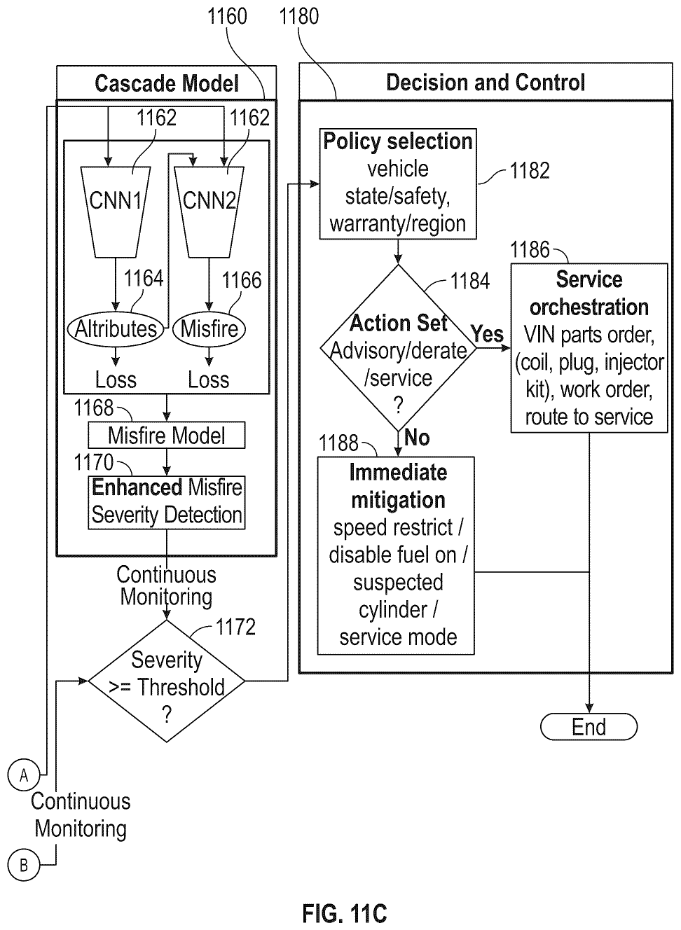

Referring now to FIG. 11A, an automotive system 1108 including an automotive controller 1110 may be coupled to a sensor 1112. The sensor 1112 may represent a plurality of different types of sensors for the vehicle including an audio sensor positioned within the vehicle or near an engine of the vehicle. The automotive controller 1110 may be an overall vehicle controller or an engine control module for detecting one or more conditions such as mis-fire of an internal combustion engine. Ultimately, the automotive controller 1110 may be used to control an actuator 1114, an engine component 1116, a fault indicator 1118, and a network interface 1120. The network interface 1120 may be in communication with the automotive controller 1110 and control a connection to a parts ordering system 1122 or a service scheduler 1124 or both. The system 1108 may be used to order parts or schedule the vehicle for service at a repair shop or dealer. The system 1108 may be used to diagnose various vehicle problems with an audio sensor 1112. Such conditions as determining a clogged intake air filter using minimum viable data using an acoustic or pressure signal as the sensor 1112 may be performed. A fault indicator 11120 may recommend a change in the filter when the severity is low. The fault indicator may generate a more severe warning when the severity escalates over a first threshold and may limit engine power when the severity exceeds another threshold. If the severity escalates, at any time, the dealer or shop may order an air filter for the customer through the interface 1120. This system improves the air filter technology and fuel economy that may be achieved by a vehicle by being predictive and not reactivated. This will allow engines to be protected and provide better fuel economy.

The system 1108 may also be used to detect the misfire of an internal combustion engine. The sensor 1112 may be an audio sensor that is used for the detection of a misfire in the engine. The misfire may be detected based upon various attributes of the fault and of the operation of the engine.

Referring now to FIGS. 11B and 11C, a detailed method for detecting misfire for an internal combustion engine of an automotive vehicle is set forth in detail. However, the teachings set forth below may be applied to other types of faults in other types of systems outside of the automotive industry. The system begins in step 1140 with a data acquisition and preprocessing at step 1140. The data acquisition and preprocessing step includes obtaining raw audio from a sensor, the speed of the engine, the load of the engine, an engine family metadata, permutable parameters, such as a rate, a window, features and sensor count in step 1142. If minimum variable data is to be used in step 1144, the system uses the minimum variable process steps in step 1146. Step 1146 comprise steps 1148 and 1150. Step 1148 provides different types of reductions to the data. The data may be plotted as performance versus budget so that a knee or inflection detection may be performed where more reduction hurts performance. That is, as described above and is illustrated in the graphs below, the Pareto data framework may be used as a means to identify the minimum viable data where more reduction hurts the performance such as the misfire detection accuracy. This can be formed mathematically as mentioned above without the need for a visual plot. In step 1150, the minimum viable data and resources information are acquired. The data acquisition from step 1150 is also performed after the number of sensors such as microphones and MEMS (micro-electrical mechanical systems) are determined in step 1152. That is, if minimum viable data is not obtained, other data such as that in step 1152 may be acquired. In step 1154, the data acquisition from either a number of sensors or a minimum viable data grouping of data may be used to obtain feature selection and extraction in step 1156. If a cascade model is used in step 1158, the cascade model in step 1160 is used. The cascade model may use convolutional neural networks 1162 to determine various attributes 1164 and misfiring in step 1166. A misfire model may be used in step 1168 and the severity detection may be used to as an enhanced misfire detection in step 1170. When the severity is above a threshold in step 1172, a decision control process is performed in step 1180. However, step 1172 is also used after the cascade model is not used in step 1158. Step 1174 is performed after step 1158 is answered negatively. That is, other models from step 1174 are used when the cascade model is not used.

After step 1172, step 1180 performs decision and control. In step 1182, a policy selection, such as a vehicle state and safety as well as warranty and the region of the vehicle, may all be used in the decision control. In step 1184, an action set may be performed. An advisory may be provided, derating the power for the engine of the vehicle or scheduling a service appointment may be performed in step 1184. When an advisory set is performed, the vehicle identification number may be used to obtain parts such as a coil, plug, an injector kit and service may be scheduled so that the parts are available when the customer arrives in step 1186. This may be done through the telematics described in FIG. 11B through the network interface 1120. When an action set is not performed, step 1188 performs immediate mitigation such as speed restriction, disable the fuel on a suspected cylinder or enter into a service mode for the engine. Of course, when other types of vehicle or engine failures are determined, various types of actions for mitigation and surface may be provided.

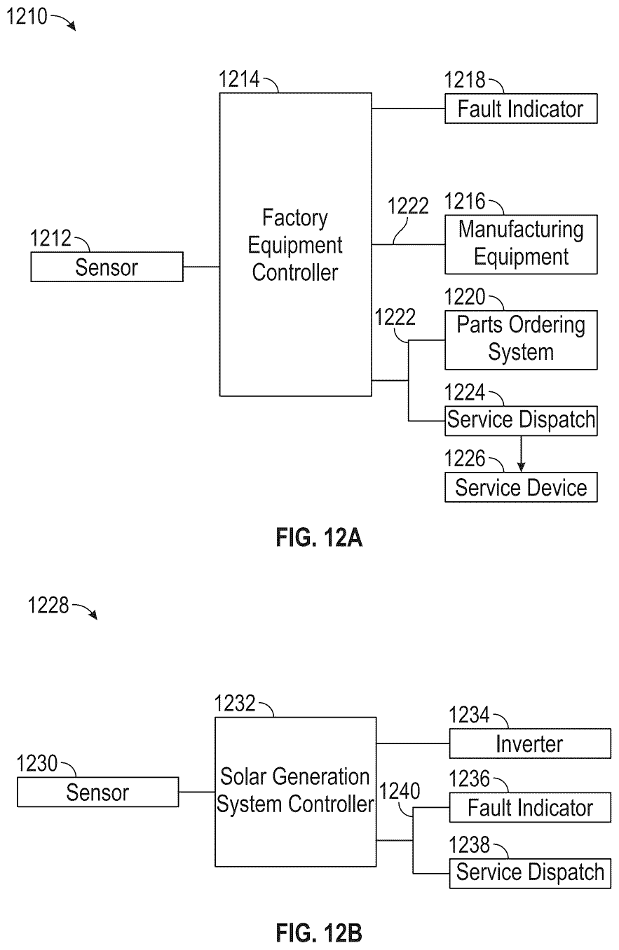

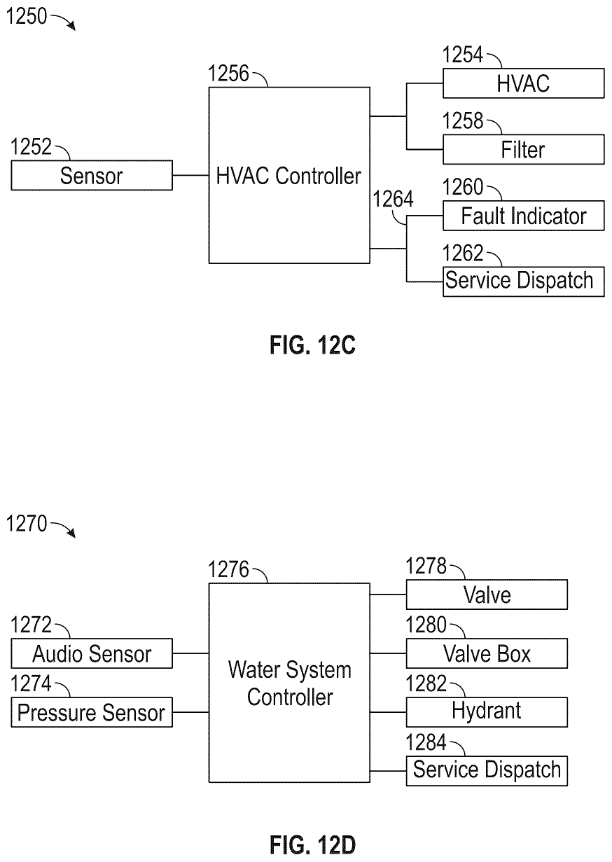

Referring now to FIG. 12A, a system 1510 for use in a manufacturing system is set forth. The system 1510 includes a sensor 1212 that provides data to a factory equipment controller 1214. The factory equipment controller 1214, as with all the controllers set forth herein may be microprocessor or processor based and have internal circuits as mentioned above 10A such as a non-volatile memory including instructions for determining the reduced data set and controlling a particular piece of equipment The controller 1214 may be coupled to various types of equipment including the manufacturing equipment 1216 illustrated. The factory equipment controller 1214 may be coupled to a fault indicator 1218 and a parts ordering system 1220. A network 1222 may couple the factory equipment controller 1214 and the parts ordering system 1220. The network 1222 may also be used to couple the factory equipment controller 1214 to a service dispatch 1224. The service dispatch 1224 may be a computer operated dispatcher that sends a dispatch signal to a service device 1226 associated with the service provider to inform them that a particular component needs to be replaced.

Various types of manufacturing systems may be monitored and controlled. For example, a compressed air network may have a sensor 1212 such as a low-rate acoustic sensor that may be used in various locations to detect the flow rate or pressure of various locations in which leaks are likely, thus the sensor 1212 may be an audio sensor combined with a flow rate sensor to estimate the likelihood of a leak. Of course, an audio sensor alone may be used. A plurality of sensors may be located in various locations, thus the sensor 1212 may represent a plurality of sensors. Various branches and valves may be adjusted as the manufacturing equipment 1216. Variable frequency drive set points and duty cycles may be adjusted to stabilize the pressure or lower the power at such devices. By using audio sensors, less invasive processes are used to determine leaks. By providing a system, continuous leak detection may be provided with far less data due to the minimum viable data set obtained. Repairs may be performed on a preventive basis and verified with the same equipment.

The manufacturing system 1510 may also include a convey line such as idler and rolling bearings as the manufacturing equipment 1216. In a complex manufacturing facility, various lines of conveyors may be used in various lines, zones and rollers. Low fidelity auto and/or vibration sensors may be used as the sensor 1212. Vibrations along the frame may be used to detect roughness and chatter. Of course, low fidelity audio signals may also be used. When multiple sensors are used, they may pinpoint the exact roller when a plurality of rollers are used. One advantage of such a system is that only the affected zone or segment may be slowed or stopped to perform maintenance. Such a system may also order parts through the parts ordering system 1220 in the network 1222. By providing the system, zone pinpointing, fewer stoppages, fewer secondary belt failures and lower maintenance labor may be achieved.

The manufacturing system 1510 may also be a CNC as the manufacturing equipment 1216. The sensor 1212 may be a vibration or audio sensor at minimal sampling where a cascade machine model is used to determine various things such as bearing wear. The sensor 1212 may also be a cap spindle speed sensor or feed sensor that may be used to avoid high-load passes or lock out if there is a risk of a threshold being acceded to prevent race/shaft damage. Ordering a bearing or spindle cartridge or scheduling a plan swap may be performed by the parts ordering system 1220 and the service dispatch 1224. Such a system applied to a CNC machine may provide minimum viable data sensing, early detection, reduced down time and may avoid damage and include the speed of resolution.

When the system is an energy system such as an inverter for a solar energy system, the DC link capacitor health may be monitored for a number of inverters within a system. Low-rate current harmonics and temperature models may be used to estimate the equivalent series resistance and ripple stress so that early degradation scores may be obtained. Various strings of solar inverters may be switched to hot-standby/parallel inverters. In addition, the maximum power point tracking may be used to reduce ripple current and lockout operation if a risk threshold is exceeded. Swapping may be scheduled during a low radiance time. In the solar power generation system application, low-rate signals current harmonics, and temperature may be used together with metadata as the sensors. Lower-rate signals, earlier de-rating, seamless hot swapping and reduced down time in energy loss may all be achieved.

Referring now to FIG. 12B, the solar system mentioned above may be implemented by a current sensor and a temperature sensor as sensor 1230. The solar system 1228 has a solar system controller 1232 that may be coupled to various components such as an inverter 1234. A fault indicator 1236 may be used to indicate a fault either on site or remotely through a network 1240. Likewise, service may be dispatched through a service dispatch located on site or through the network 1240.

Referring now to FIG. 12C, a building system 1250 may benefit from the teachings set forth herein. A sensor 1252 such as a differential pressure sensor or a low-rate microphone or combination of both may be used. A fan current sensor may also be used to determine a clog in a heating ventilation and air conditioning system 1254. A HVAC controller 1256 couples to the HVAC system 1254 and may be used to control various functions such as stopping a fan briefly to confirm a clog or detect belt slip or tension drift in the HVAC system. The system may perform auto adjustment for the variable frequency drive and the set points to maintain air flow throughout the building. The filter 1258 may be prompted for changing based upon the flow therethrough. The system may have a staged shutdown or a reduced mode if a slip or clog within the system appears. The system may be locked out if certain thresholds are crossed. A fault indicator 1260 and a service dispatch may all be used to indicate a fault and/or dispatch surface to fix a fault.

Referring now to FIG. 12D, a water system 1270 has one or more audio sensors 1272 and one or more pressure sensors 1274. The audio sensor 1272 and the pressure sensor 1274 may be provided at various locations. A water system controller 1276 is in communication with the audio sensor 1272 and the pressure 1274. The sensors may be located through various parts of the system including at a valve 1278, a valve box 1280 and a hydrant 1282. By monitoring the audio signals and vibration at hydrants and valve boxes, as well as pressure analytics, localization leak probability may be determined. That is, leakage valves, valve boxes and hydrants can be monitored by audio sensor 1272 and pressure sensors 1274. Segments may be isolated by closing upstream and downstream valves, reducing set points and operating pressures to limit losses. Crews may be dispatched to a service dispatch 1284. The location of the audio sensor 1272, the pressure sensors 1274 and/or the valves 1278, the valve boxes 1280 and the hydrants 1282 may all be known through global positioning system and a plan. Inexpensive contacting systems are thus provided by the present monitoring system to allow continuous testing and target isolation to reduce non-revenue water and obtain faster repairs.

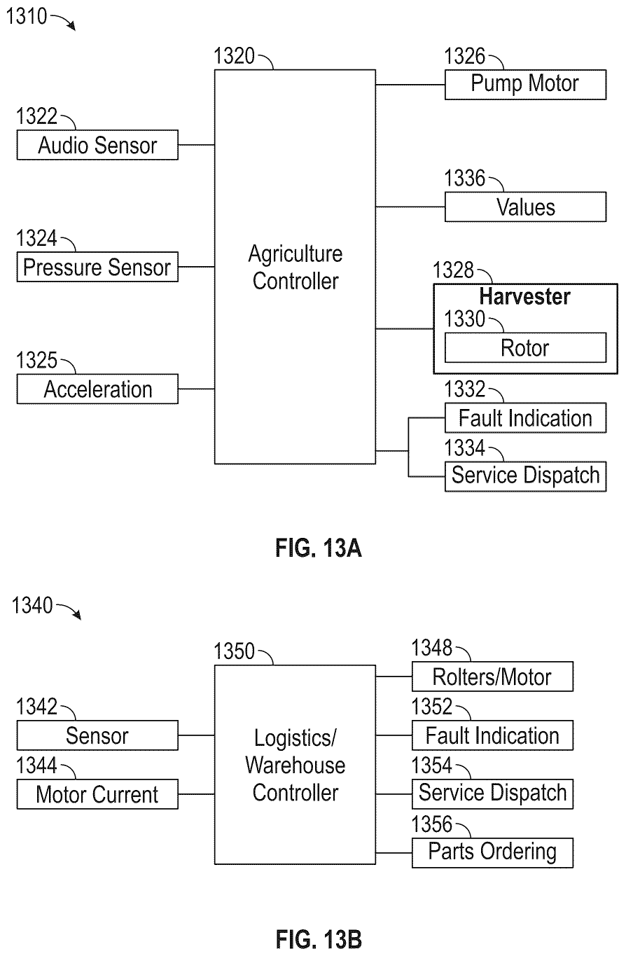

Referring now to FIG. 13A, an agricultural system 1310 is illustrated. An agricultural controller 1320 may be coupled to an audio sensor 1322 or a pressure sensor 1324 or both depending on the type of agricultural product. The agricultural controller 1320 may be used to control the irrigation network or a harvester. The irrigation system may include a pump motor 1326 and the harvester 1328 may include a rotor 1330. In an irrigation system, both an audio sensor 1322 and a pressure sensor 1324 may be provided. The irrigation network may be distributed over vast areas and thus various pumps may be provided in various locations. The locations of each are known. The irrigation network may use the acoustic minimum value data as well as pressure sensors 1324 to detect protect pressure and flow transient to detect incipient cavitation and estimate the severity thereof. A fault indicator 1332 and a service dispatch 1334 may be used to indicate the severity of a fault and dispatch service employees to the location. The speed of the pump motor 1326 may be adjusted as well valves 1336. That the valves 1336 may allow parallel pumps to be used in place of a failing pump. The pump motor 1326 may be controlled by a variable frequency drive of which the frequency or set points may be adjusted based upon detected potential faults. Locking out a particular pump motor may be performed if a risk threshold is exceeded. Because the locations are known, crews may be dispatched through the dispatch service 1334 to address various issues. The improvements in the system provide a low data continuous system with earlier mitigation, fewer outages and lower energy.

When the agricultural system is a combine, harvester, a rotor jam may be determined. Cascaded interference may include a cavern microphone. In addition, an accelerometer 1325 may be provided to detect a rising load and classify a likely blockage. A slow rotor may be determined. This may provide prompting through the fault indicator 1332 for an operator to clear the blockage. Operation may be resumed at an optimized speed once the clear is performed. In a harvester system, cheaper targeted clearing is indicated. Earlier slowdowns, fewer full stops and reduced losses and wear may also be indicated by the fault indicator 1332.

Referring now to FIG. 13B, a logistics system or warehouse system 1340 may be provided. The system 1340 may include a sensor 1342 which may comprise a plurality of sensors distributed throughout a warehouse or logistic environment. A motor current sensor 1344 may also provide motor currents of various movement motors at various locations. Rollers/motors 1348 may be controlled by a logistics/warehouse controller 1350. The minimum viable data may be determined at the system using the audio as well as the motor current 1344. Bearing roughness, roller drag, or motor imbalance may all be determined and localized to a lane or position within the logistics or warehouse environment. A fault indicator 1352 may be used to indicate a fault, the type of fault and the location of the fault within the system 1340. A service dispatch 1354 may be used to determine when a serving crew may be dispatched. Likewise, the position may be pinpointed because the sensors may be distributed throughout, and their locations are known. Logistics and warehouse systems are typically complex and may allow line speed to be changed or the system to reroute the flow of goods. When a risk threshold is exceeded, the lockout of a device may be performed. Service dispatch 1354 may be used to dispatch service to a particular location. A parts ordering system 1356 may be used to order parts such as roller, motor or bearing kit which may be labeled with an aisle, zone or bay location so that the service dispatch 1354 may dispatch the proper part to the proper location in an expedited manner. The scheduling system may also schedule the swap of the defective part with a properly operating component when the system is in a lull. The system improves current systems by providing a low data auto location system with fewer stoppages and faster repair times.

Various ways to reduce data are set forth below. The types of reduction may be used alone or in combination. The reduction types were evaluated in four phases, each focusing on a specific aspect of resource optimization: (1) Down sampling: Sample rate determines the frequency range that can be accurately captured. Lower sample rates result in a reduced reliable frequency range, but offer smaller file sizes, lower bandwidth requirements, and potentially reduced energetic and economic costs as fewer data points are recorded per second. By adjusting the sample rates across a spectrum, this phase evaluated classification accuracy and measured benefits and tradeoffs of decreased data transmission. Sample rates of 44 kHz, 22 kHz, 16 kHz, 8 kHz, and 4 kHz were considered. (2) Quantization: Bit depth determines the precision of each sample in an audio. Lower bit depths directly correlate with reduced data rates and lower bandwidth consumption. Halving the bit depth from 16 bits to 8 bits also halves the data rate. The phase measured bandwidth savings weighed against the loss in classification accuracy. Each audio file was quantized to 16, 12, 10, 8, and 4 bit depth. (3) Combined Sample Rate and Quantization: This phase simultaneously varied both sample rate and bit depth to analyze their combined impact on classification performance. By adjusting these parameters together, the aim was to better understand their interaction and potential benefits or detriments to performance and resource use. (4) Segmentation: This phase reduced clip length with the aim of ascertaining the minimum viable clip length that retains sufficient informational content for accurate classification, reflecting on storage and computational resource savings. The TESS and MNIST datasets began with 2 and 1 second samples, so had little opportunity for meaningful truncation. ESC 50 began at 5 seconds and was segmented into clips from 1.0 to 5.0 seconds at half-second intervals.

Similarly, the GTZAN dataset, with its original 30-second clips, was more gradually segmented down to intervals between 1 and 30 seconds, stepping down in increments of 10 seconds, 5 seconds, and finally 1 second. Specific values for periodic down sampling—sample rates of 44, 100 Hz, 22,050 Hz, 16,000 Hz, 8,000 Hz, and 4,000 Hz—to represent a range from high-fidelity sensors (44, 100 Hz), which are expensive and resource-intensive, to low-cost, energy-efficient sensors (4,000 Hz) suitable for resource-constrained environments; these values reflect various sensor capabilities were selected. For quantization, the bit depths of 16 bits, 12 bits, 10 bits, 8 bits, and 4 bits were chosen to simulate the trade-off between data precision and resource consumption: 16 bits represent high-precision sensors with greater costs and power needs, while 4 bits reflects minimal precision for ultra-low-cost sensors with minimal storage and energy requirements. Clip lengths were varied from 1 to 30 seconds (for the GTZAN dataset) and 1 to 5 seconds (for the ESC-50 dataset) to assess the impact on data volume and processing time, with longer clips representing detailed monitoring at higher operational costs, and shorter clips simulating more efficient data collection with reduced storage and computational demands. By experimenting with these specific values, a spectrum of sensor types and configurations were emulated that directly affect initial investments and ongoing operational costs. Prior to experimentation, each audio file underwent pre-processing, including normalization and feature extraction using Mel-frequency Cepstral Coefficients (MFCCs). MFCCs are commonly used in audio processing due to their effectiveness in representing the spectral properties of sound. For each audio file, MFCCs were computed using a 40-coefficient representation; these were the only features generated as they are effective at capturing the essential spectral characteristics of audio signals, particularly for resource constrained tasks. MFCCs reduce dimensionality and preprocessing complexity while maintaining moderate information fidelity and noise robustness.

In each phase, to emulate the decision-making process that might be carried out by a sensor's data processing system in real-world applications, SVM classifiers are chosen and accuracy as performance metric. It is one of the Algorithms discussed in the previous section that aligns closely with the operational constraints and efficiency needs of sensor systems. MFCCs have also been shown to perform well with SVM. The graph was plotted for accuracy against varying levels of sample rate, bit depth, and clip length for each dataset. The results were plotted to identify the knee or inflection point—where accuracy begins to degrade sharply after incremental data reductions. The inflection point represents the practical limit for data optimization (the location of MVD), highlighting the point at which further reductions result in significant performance loss. Identifying this threshold is critical for balancing resource efficiency with performance. In some cases, the inflection is clearly defined, while in others, the performance degradation may be more gradual, making it challenging to pinpoint an exact inflection point. These experiments hold the potential to validate the concept of MVD by systematically exploring the trade-offs between data reduction and accuracy. The results provide a robust foundation for generalizing the Pareto Data Framework across a wide range of IoT and constrained computing applications, paving the way for more efficient, sustainable, and accessible machine learning solutions in resource-constrained environments. This section highlights the trade-offs between resource use and machine learning performance. The inflection points for “minimum viable data” (MVD) were identified in various classification applications and across datasets, focusing on how these findings generalize and impact real-world optimization of constrained device. By systematically reducing bit depth, sample rate, and clip length, the balance to data efficiency and computational performance, establishing the validity of the Pareto Data Framework as a means of identifying the Minimum Viable Data in certain context is demonstrated.

Referring now to FIG. 14, reducing sample rates allowed us to identify the point at which lower frequencies begin to limit classification accuracy. Across all datasets, clear inflection points emerged, indicating where performance stabilized despite further reductions in sample rate. In the TESS dataset, accuracy increased up to around 11,000 Hz at inflection point 1410A, with diminishing returns beyond that point. For GTZAN, accuracy plateaued around 20,000 Hz at inflection point 1410B. The MNIST dataset showed peak performance at a lower rate (10,000 Hz) at inflection 1410C, reinforcing the Pareto principle, as this dataset required less data to achieve high accuracy. ESC-50 exhibited an inflection point 1410D around 7,000 Hz, where further sample rate increases yielded marginal benefits. In each dataset, the majority of the performance is achieved with a relatively low sample rate. These results highlight the potential to significantly reduce sample rates, sometimes down to 25% of the original rate—while retaining 90-99% of performance. This reduction translates into substantial bandwidth, energy, computation, and storage savings, reinforcing the applicability of the Pareto Data Framework to a wide range of AI applications in edge and constrained devices.

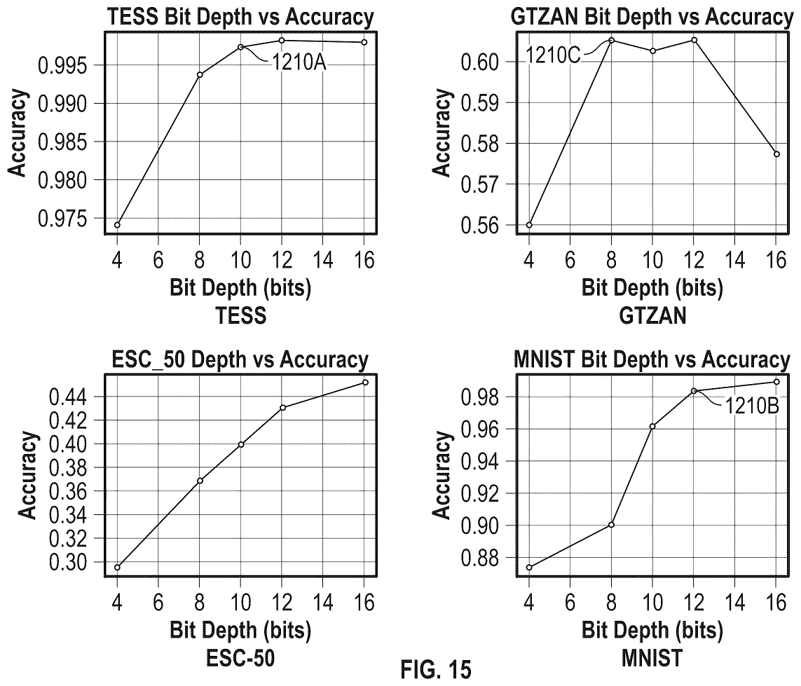

Referring now to FIG. 15, a bit depth reduction may also be performed. The impact of bit depth from a quantization of 4-bit depth to 16-bit depth on performance across datasets was performed for the various datasets used in FIG. 14, with a focus on balancing precision and resource usage (bit depth as a proxy for economic, energetic, and network costs). The results revealed inflection points where further reductions in bit depth began to degrade classification accuracy. For the TESS dataset, accuracy increased sharply as bit depth rose from 4 to 8 bits and stabilized after 10 bits, indicating that 8-10 bits is the most resource-efficient range as indicated by inflection point 1510A. MNIST followed a similar trend, with the optimal performance occurring between 10-12 bits at inflection point 1510B. For GTZAN, the inflection point 1510C occurred at 8 bits, with further increases introducing minimal gains or slight decreases, likely due to the complexity and excessive granularity of the audio patterns as the precision increases, causing an overfit. ESC-50 showed a consistent increase in accuracy as bit depth rose, with no clear knee or inflection point, suggesting a more linear relationship between bit depth and performance in this dataset, suggesting fewer potential “savings” in quantization, and indicating that differing classification tasks may offer varied knee or inflection point locations, or linearity of input to output quality. In the ESC 50 data set, bit depth does make an impact in a later section when reduced simultaneously with sample rate, showing that some parameters of data might not make impact individually but still show potential for a characteristic inflection point. As expected, higher bit depths initially exhibited higher accuracy, capturing finer details and nuances in the audio data. A common finding was that accuracy can be largely maintained even with significant reductions in bit depth. One plausible reason for this is that beyond a certain threshold, increasing bit depth captures non-informative features, including additional noise. The results support the MVD principle by showing how data collection can be optimized for performance without unnecessary resource consumption. Reducing bit depth by half cuts bandwidth by 50%, demonstrating the potential for significant resource savings without sacrificing accuracy.

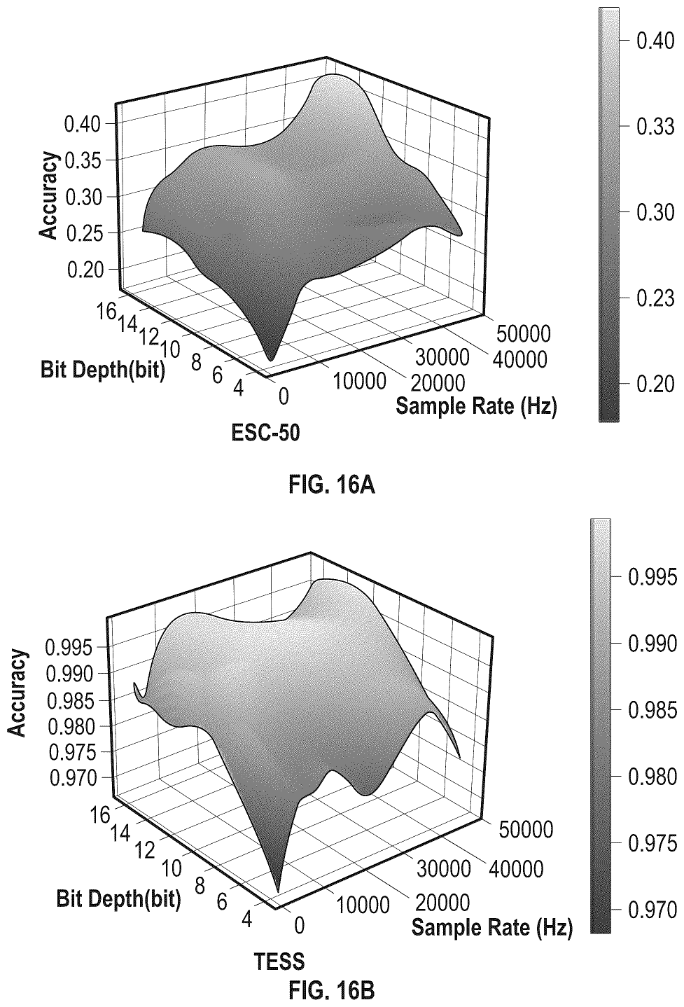

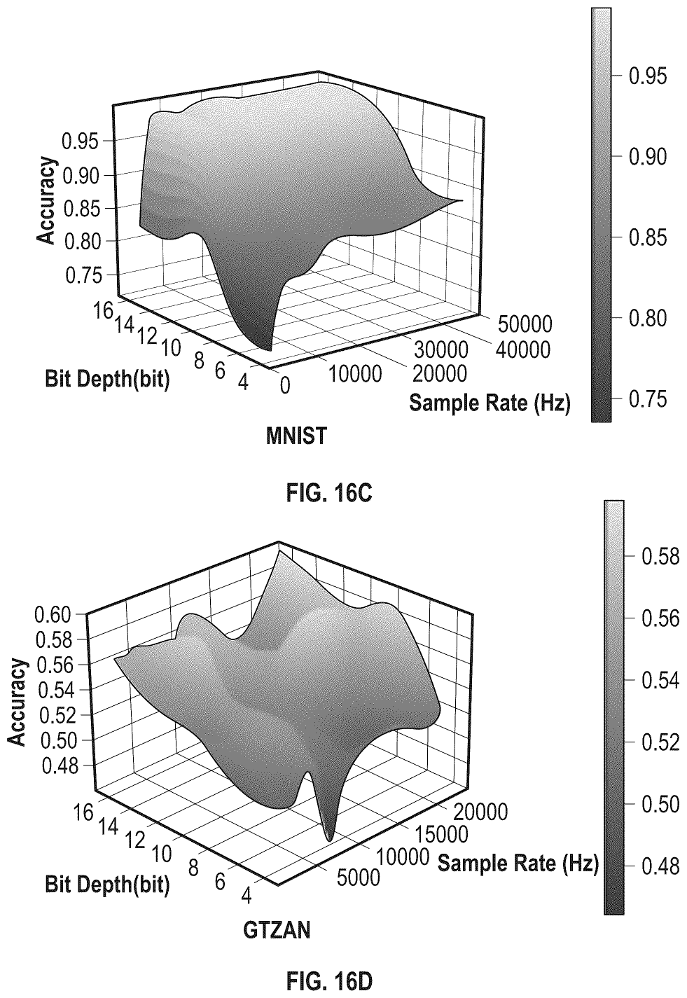

Referring now to FIG. 16, when bit depth and sample rate were reduced simultaneously, the results further validated the Pareto Data Framework. The TESS and ESC-50 datasets showed accuracy stabilizing after key thresholds (20,000 Hz and 8 bits for TESS, and 20,000 Hz and 12 bits for ESC-50). GTZAN displayed more fluctuation, but the general trend confirmed that most accuracy gains could be achieved with moderate levels of both sample rate and bit depth. For MNIST, the knee or inflection point occurred earlier, with high accuracy retained even at lower data quality levels. This emphasizes that simpler datasets benefit from more aggressive data reduction, making them prime candidates for resource-efficient implementation in constrained environments. The combined approach confirms that both dimensions can be reduced in tandem, offering a multi-dimensional method for optimizing data efficiency without sacrificing performance. This multidimensional reduction reasoning allows for a more holistic optimization process, where multiple data dimensions are fine-tuned in tandem to reach the collective inflection point demonstrating the Framework's applicability across diverse and complex scenarios.

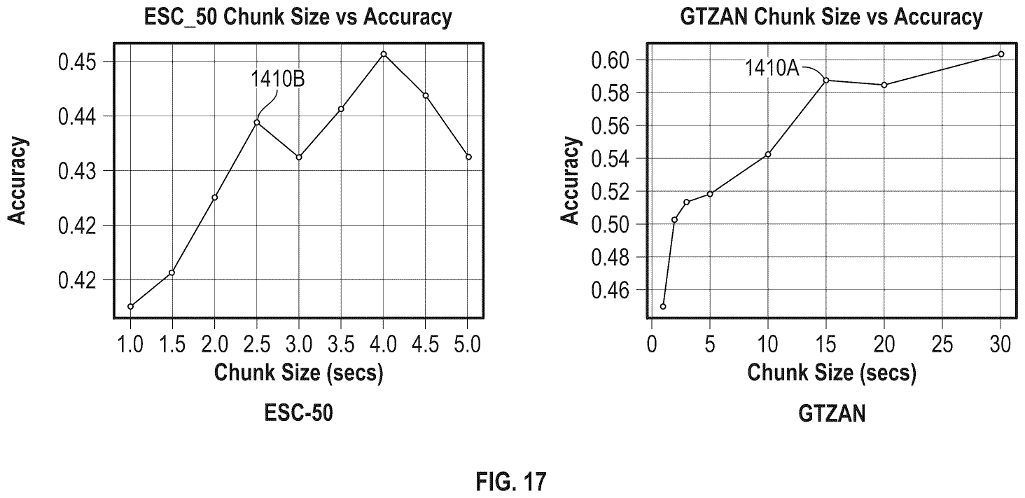

Referring now to FIG. 17, shortening audio clip length was also used as helped to identify the minimum viable duration for maintaining classification accuracy. For the GTZAN dataset (with original clip length of 30s), accuracy improved as chunk size increased up to 15 seconds at inflection point 1710A, after which performance plateaued. Similarly, ESC-50 saw performance stabilize at 2.5 seconds at inflection point 1710B, suggesting that clip lengths could be reduced while maintaining up to 95% of the original accuracy. Reduction through this framework could potentially halve the file size (File size=Bitrate×Clip Length), while still retaining performance of up-to 95% of original accuracy, leading to more efficient storage and processing. By reducing clip lengths, substantial reductions in file size were achieved, improving storage and processing efficiency without major losses in performance. This further validates the flexibility of the Pareto Data Framework in adapting to various data characteristics and application needs.

While the above results are demonstrated on audio data, the principles of data reduction through MVD can generalize to other time-series data such as sensor networks, visual data streams, and environmental monitoring. In these domains, parameters such as frame rate (for video) or sampling intervals (for sensor networks) can be optimized similarly to achieve resource-efficient machine learning.

In real-world, for a given application particularly when no prior collected dataset is available, a practical approach is to tune the application parameters incrementally adjusting them until a noticeable dip in performance occurs, pinpointing this inflection point as the threshold for optimal data use. In context of broader deployment of this framework, which involves dealing with several related applications to those previously studied, the established inflection points provide a useful starting guideline, allowing for minor adjustments based on specific data characteristics. It can also involve utilizing statistical and learning models over the previously studied relationship between data quality and model performance, thereby reducing the need for extensive experimentation. Ns such as environmental monitoring, smart cities, and industrial IoT, where efficient data collection and processing are critical. For instance, in smart city infrastructure, the framework offers a means to optimize data collection from sensors monitoring traffic, pollution, and public safety. By reducing energy, bandwidth, and operational costs, the framework can enable more efficient real-time decision-making without overwhelming the underlying constrained computing infrastructure. Similarly, in precision agriculture, the framework allows for the strategic deployment of sensors to monitor soil conditions, equipment health, and environmental factors, making these advanced technologies more accessible to small and medium sized farms. This scalability enhances precision agriculture practices by making sophisticated monitoring tools more cost effective.

The framework also has significant implications for transportation and infrastructure. In off-board vehicle monitoring, for example, using less sensitive microphones and lower sampling rates still allows for the accurate detection of anomalies, such as engine knocks or exhaust leaks. This enables manufacturers to deploy diagnostic systems more widely across fleets without increasing costs or resource consumption. The broader adoption of acoustic diagnostics can improve vehicle safety and reliability, as well as reduce maintenance costs.

Consider a factory manager tasked with setting up and operating a sensing system for 10 years with a budget of $1000. In a traditional approach, with an assumed linear relationship between cost and data quality, the manager could install a single high-quality sensor on one piece of equipment. This sensor would provide detailed, lab-grade data, but it would only offer insight into that single machine-leaving the rest of the factory unmonitored. With the Pareto Data Framework and the concept of Minimum Viable Data, the same budget can instead be used to install 100 lower-cost vibration sensors across 100 pieces of equipment. While each sensor may not capture the highest possible fidelity, together they provide a comprehensive, system-wide view of the factory's operations—the “30,000 foot view.” These sensors deliver directional insight, enabling the manager to observe general trends in performance, detect inefficiencies, and anticipate maintenance needs across the entire operation. This broader sensor network can serve as the foundation for an effective decision support system. By collecting data from multiple points, the system can identify patterns, relationships, and trends that would be invisible with isolated high-fidelity data. For instance, a drop in power consumption across several machines might indicate the onset of wear in a specific part of the production line, prompting proactive maintenance before a breakdown occurs. Similarly, real-time insights from many sensors allow the factory manager to adjust production schedules dynamically, optimize resource allocation, and improve overall throughput. Even though the data from each sensor is not perfect, its aggregation allows for a deeper understanding of the factory's operations, creating a feedback loop that continuously informs decision-making. The ability to monitor more equipment and track long-term performance metrics leads to better forecasting of maintenance needs, reducing unexpected downtime and extending the lifespan of critical machinery. Additionally, the cumulative insight from this distributed network supports more informed decisions about energy consumption, quality control, and efficiency improvements, which can drive significant cost savings over time.

In this way, the Pareto Data Framework transforms a limited budget into a scalable, intelligent monitoring solution. It maximizes the utility of available resources by emphasizing breadth of coverage rather than precision at a single point, helping the factory manager make smarter, data-driven decisions that enhance operational efficiency and support the factory's long term growth.

In this present disclosure, Pareto Data Framework, a novel approach for optimizing data collection and processing in resource-constrained environments. Our experiments with sensor data proxies confirm that optimizing parameters like sample rate, bit depth, and clip length significantly reduces resource consumption while preserving performance, validating the Pareto Data Framework. Future work will extend the framework to domains such as visual and environmental data, further refining MVD for broader constrained systems applications. Our results validated the presence of inflection points in the data, where the relationship between input and output quality changes significantly. This finding challenges the prevailing notion that more or higher-quality data always leads to better outcomes. The framework paves the way for more sustainable AI and machine learning practices, enabling broader deployment of these technologies across industries and regions where resource constraints have been barriers to progress.

The Pareto Data Framework offers immediate practical benefits for a wide range of mobile and constrained applications. By focusing on capturing only the most essential data, systems can be designed to operate efficiently within resource limits. In mobile and edge AI, reducing data fidelity can extend battery life and lower energy consumption, making advanced AI capabilities feasible in resource-limited settings. Similarly, in environmental monitoring, lower power requirements and smaller data transmissions allow for longer-term, remote deployment of sensors. In industrial IoT, for instance, this approach enables the deployment of more sensors across more machines, providing broader operational insights without incurring excessive costs. However, the exploration of the Pareto Data Framework is only beginning. Future research will extend its application beyond acoustic data to other domains such as acceleration, visual data, and complex sensor networks. Each of these domains presents unique challenges that will require the development of new methodologies and algorithms tailored to their specific data characteristics. This will further refine the concept of Minimum Viable Data (MVD), maximizing data efficiency while preserving the utility of machine learning insights.

Additional exploration into the integration of the Pareto Data Framework with edge computing offers promising opportunities. By bringing data processing closer to the source, edge computing complements data efficiency, potentially enhancing the framework's application in real-time, latency-sensitive use cases. Our long-term goal is to generalize the framework's principles, developing mathematical models that can predict optimal data reduction strategies across various applications, with or without representative data. This effort will distill the insights from our empirical studies into a set of guiding principles and tools for practitioners. Future work will also focus on more rigorous evaluation methods that account for total resource costs in specific operating contexts, ensuring that the Pareto Data Framework continues to drive innovation in resource efficient AI deployment.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the examples is described above as having certain features, any one or more of those features described with respect to any example of the disclosure can be implemented in and/or combined with features of any of the other examples, even if that combination is not explicitly described. In other words, the described examples are not mutually exclusive, and permutations of one or more examples with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python.

What is claimed is:

1. A method of operating a device comprising:
generating a first set of raw data;
reducing the first set of data using a plurality of reductions to obtain reduced sets of data and a performance factor for each reduced data set to determine an inflection point relative to the performance factor;
determining a second data set reduced from the set of raw data based on a reduction from the plurality of reductions at or below the inflection point; and
controlling a device based on the second data set.

2. The method of claim 1 wherein generating the first set of raw data comprises generating the first set of raw data from an audio sensor.

3. The method of claim 1 wherein generating the first set of raw data comprises generating the first set of raw data from a pressure sensor or a current sensor.

4. The method of claim 1 wherein generating the first set of raw data comprises generating the first set of raw data from historical data.

5. The method of claim 1 wherein generating the first set of raw data comprises generating the first set of raw data from an input data stream.

6. The method of claim 1 wherein generating the first set of raw data comprises generating the first set of raw data from an automotive sensor and controlling the device comprises controlling an engine control module.

7. The method of claim 1 wherein compressing the first set of data comprises performing down sampling.

8. The method of claim 1 wherein compressing the first set of data comprises performing quantization using bit depth.

9. The method of claim 1 wherein compressing the first set of data comprises performing two types of reduction.

10. The method of claim 9 wherein performing two types of reduction comprises compressing the first set of data comprises performing down sampling and quantization using bit depth.

11. The method of claim 1 wherein determining the inflection point comprises determining an 80-20 inflection point.

12. The method of claim 1 wherein controlling the device comprises controlling an agricultural system.

13. The method of claim 1 wherein controlling the device comprises controlling a heating ventilation and air conditioning system.

14. The method of claim 1 wherein controlling the device comprises controlling a water system.

15. The method of claim 1 wherein controlling the device comprises controlling an agricultural system.

16. The method of claim 1 wherein controlling the device comprises controlling a logistics system.

17. A system comprising:
a sensor;
a controller programmed to receive a first set of raw data from the sensor;
reduce the first set of data using a plurality of reductions to obtain reduced sets of data and a performance factor for each reduced data set to determine an inflection point relative to the performance factor;
determine a second data set reduced from the set of raw data based on a reduction from the plurality of reductions at or below the inflection point; and
control a device based on the second data set.

18. The system of claim 17 wherein the sensor comprises an audio sensor.

19. The system of claim 17 wherein the sensor comprises a pressure sensor or a current sensor.

20. The system of claim 17 wherein the reduction comprises the first set of data comprises performing down sampling or quantizing using bit depth.

21. A method of detecting misfire in a vehicle operating a device comprising:
generating a first set of audio data from an audio sensor positioned within the vehicle;
reducing the first set of data using a plurality of reductions to obtain compressed sets of audio data and a performance factor for each reduced data set to determine an inflection point relative to the performance factor;
determining a second data set of audio data reduced from the set of audio data based on a reduction from the plurality of reductions at or below the inflection point;
determining a misfire based on the second set of audio data; and
controlling an engine control module based on determining a misfire from the second set of audio data.
